(19) United States
(12) Patent Application Publication
(10) Pub. No.: US 2008/0027841 A1
(43) Pub. Date: Jan. 31, 2008

(54) System for integrating enterprise performance management

(76) Inventor: Jeff Scott Eder, Mill Creek, WA (US)

Correspondence Address: ASSET TRUST, INC., 2020 MALTBY ROAD, SUITE 7362, BOTHELL, WA, 98021, US

(21) Appl. No.: 10/046,094

(22) Filed: Jan. 16, 2002

(51) Int. Cl. G06Q 40/00

(52) U.S. Cl. 705/35

(57) ABSTRACT

An automated system (100) for integrating narrowly focused management systems in to a financial measurement and optimization system for a multi-enterprise commercial organization. A matrix of market value is developed for each enterprise in the organization. The matrices of market value are then used to guide the integration of narrow systems in to the organization's financial system. Value and risk are analyzed by element of value on the system date as required to complete and display the matrix of market value for the organization by enterprise. A series of scenarios under both normal and extreme conditions are then developed. The information from these scenarios is then combined with market value matrix information to determine the optimal mode for financial management. The information on the optimal mode of organization operation is then communicated to the integrated narrow systems for implementation. The efficient frontier for organization financial performance is also calculated, displayed and optionally printed.

### CROSS REFERENCE TO RELATED APPLICATION

The subject matter of this application is related to application Ser. No. 10/012,374, filed Dec. 12, 2001.

### BACKGROUND OF THE INVENTION

This invention relates to a method of and system for flexibly integrating all the systems within a multi-enterprise commercial organization into an overall system for measuring and optimizing financial performance.

Managing a business in a manner that creates long term value is a complex and time-consuming undertaking. This task is complicated by the fact that traditional financial and risk management systems do not provide sufficient information for managers in the Knowledge Economy to make the proper decisions. Traditional systems are also limited in their ability to support the effective management of multi-enterprise organizations like “virtual value chains” and corporations with multiple operating companies.

In an apparent attempt to overcome the limitations associated with traditional management systems, a staggering variety of systems have been created over the last few years to manage the elements of value, real options and risks associated with operating a modern corporation. A partial list of the different types of systems that have been created in the last few years is shown in Table 1 below.

TABLE 1

```
  1. alliance management systems,
  2. asset management systems for capital and IT assets,
  3. brand management systems,
  4. business intelligence systems,
  5. call management systems,
  6. channel management systems,
  7. content management systems,
  8. customer relationship management systems,
  9. demand chain systems,
10. email management systems,
11. employee relationship management systems,
12. energy risk management systems,
13. fraud management systems,
14. incentive management systems,
15. innovation management systems,
16. intellectual property management systems,
17. investor relationship management systems,
18. knowledge management systems,
19. location management systems,
20. maintenance management systems,
21. partner relationship management systems,
22. performance management systems (for IT assets),
23. price optimization systems,
24. private exchanges,
25. product life-cycle management systems,
26. project portfolio management systems,
27. risk simulation systems,
28. sales force automation systems,
29. scorecard systems,
30. service management systems,
31. six-sigma quality management systems,
32. supplier relationship management systems,
33. support chain systems,
34. technology chain systems,
35. unstructured data management systems,
36. visitor (web site) relationship management systems,
37. weather risk management systems,
38. workforce management systems, and
39. yield management systems
```

These new systems come on top of new versions of the traditional systems that most companies have had in place for some time including those shown in Table 2 below.

TABLE 2

```
  1. a basic financial system like a general ledger,*
  2. a budgeting/financial planning system,
  3. a cash management system,
  4. commodity risk management systems,
  5. a credit-risk management system,
  6. a human resource management system,*
  7. an interest rate risk management system,
  8. a material requirement planning system,*
  9. process management systems,
10. project management systems,
11. a risk management information system,
12. a strategic planning system, and
13. a supply chain management system
*all 3 applications are usually bundled within an erp system
```

Many if not all of these new systems and upgraded traditional systems listed in Tables 1 and 2 also include the ability to calculate trends, identify performance indicators and determine the parameters that would optimize the element, process, option or risk that is being “managed”. While each of these systems and their analytical extensions may have some value to some subset of the people in each organization, the usefulness of these systems to each organization as a whole is extremely limited for a variety of reasons.

The first major limitation is a product of the fact that each of the systems listed in Table 1 is limited to processing the data associated with the element, option, process or risk they are being used to manage. As a result, each system is in effect an un-connected island of information. This has two impacts. First, these systems do not have any direct insight in to the best course of action from an enterprise perspective. Second, they can not take in to account the interaction between different elements, processes, options and risk. As a result, the theoretical benefits that arise from managing and “optimizing” these subsets are not clearly related to producing benefits for the enterprise or organization. In fact, the opposite may be true as unintended consequences and overlooked relationships can turn out to be more important than the theoretical benefits of following the course of action recommended by one of these systems. An example of the problem that overlooked information can create for an organization would be when the customer relationship management system recommends the increase in purchase of an item for a favored customer that comes from the lowest quality, highest cost supplier. Even if the product can be obtained, the poor quality of the product is likely to antagonize a favored customer and the high-cost is likely to produce little profit. Along the same lines, money may be spent to hedge commodity risk while exposure to greater risks from environmental damage may go unexamined and unprotected.

Given the preceding discussion, it should come as no surprise that corporations are not realizing much benefit from installing systems like those listed in Table 1. A leading market research firm recently noted that very few firms are reporting successful customer relationship management projects, though there is definitely a need for systems to improve customer services and retain existing clients. Another market research firm reported failure rates approaching 80% for customer relationship management systems. Similar failure rates have been reported for balanced scorecard systems and visitor management systems.

The second major limitation of all of the systems listed in Table 1 is that they are exclusively focused on only one segment of enterprise value. As a result, they ignore the value that an enterprise or multi-enterprise organization can create within the other four segments of value by effective management of the element, option, process or risk being analyzed. More specifically, most of the systems listed in Table 1 are focused on the current operation segment of value while ignoring the other four segments of business market value—real options, derivatives, excess financial assets and market sentiment. In some cases, the focus on the current operation segment of value is justified. However, in many cases the greater part of the market value impact from effective management of an element, option, process or risk is overlooked when the other segments of value are ignored.

The third major limitation of the systems listed in Table 1 and Table 2 is that they have a piecemeal approach to risk analysis. More specifically, none of the systems listed in the two tables can complete an integrated analysis of all four major classes of risk facing an enterprise: element variability risk, external factor variability risk, event risk, and market risk. In a similar fashion, most event risk analyses are limited to analyzing the impact of natural disasters, weather and accidents while ignoring far greater potential damage from events caused by competitor actions and customer defection. This limitation extends to all known attempts to manage specific risks and all known attempts to manage enterprise risk. The problem with this is that some risks are analyzed in detail while other risks—which may be more significant—are ignored.

The fourth major limitation of the systems listed in Table 1 and Table 2 is that they do not in any way address the inter-relationship between the return from the elements and options within the enterprise and the risks facing the enterprise. This is a critical oversight since the Capital Asset Pricing Model established many years ago that the market value of enterprise equity is at least in part a function of the risk and return associated with the enterprise. Advances in game-theoretic capital asset pricing models have only strengthened this argument in recent months.

A closely related limitation of even the most advanced enterprise risk and enterprise financial management systems is that they do not provide any information about expected value given the risks facing the enterprise or organization. By way of contrast, stock market portfolio analysis systems are used to guide investment managers to reasonable expectations regarding expected returns given the riskiness of their portfolio. The efficient frontier in modern portfolio theory is defined by the maximum expected return for every level of portfolio risk. A system capable of identifying the efficient frontier for managing a corporate portfolio of assets, options and risks would alleviate this problem.

It may be possible in the long run to displace the narrowly focused systems listed in Tables 1 and 2 with systems that are capable of developing and/or using the enterprise perspective for analysis and decision making. However, this solution does nothing in the short or medium term to solve the problem. Replacing the existing narrowly focused systems also does nothing to leverage the enormous installed base of narrowly focused systems that many multi-enterprise organizations have installed over the years. It is also worth noting that while these systems leave a lot to be desired in their capabilities for financial management and analysis, they also perform administrative functions that are valuable and can not readily be discarded. Effective use of the installed base of narrowly focused systems in an overall system for measuring and optimizing enterprise financial performance requires the development of a method and system for integrating these systems with the enterprise level analysis system. More specifically, a method and system for integrating the systems listed in Tables 1 and 2 with an overall financial measurement and optimization system is required.

The generic need for better integration between different applications has been recognized for some time by the technical community. One writer recently noted, “most businesses are home to scores of information systems that remain uselessly disconnected from one another.” Before applications are integrated they are usually interfaced with one another so that they can exchange information. Interfacing applications has until recently required writing customized applications to interface between different applications to extract and process the required information. Because writing customized interfaces is very time consuming, very few systems have real time interfaces and even fewer are fully integrated with other systems. The result is as described above—systems that are “uselessly disconnected.”

In an attempt to overcome this problem the global technical community is promoting a global effort to establish xml and other “standards” to reduce the amount of specialized programming required to interface (not integrate) disparate systems. Unfortunately, the same narrow perspective that limits the effectiveness of the systems listed in Tables 1 and 2 has also permeated the attempts to establish standards for communicating between systems. More specifically, if all the known, proposed global standards were in place in the systems listed in Tables 1 and 2, then the system of the present invention would be required to communicate using at least six different “standards” (listed in Table 3).

TABLE 3
Standards

1. XML - extensible markup language
2. BPML - business process modeling language
3. FPML - financial products markup language
4. XBRL - xml for business reporting
5. EBXML - e business xml
6. Acord-Wise JV Standards - insurance standards

Unfortunately, a customized interface would still be required just to obtain the data required for measuring and optimizing financial performance for the multi-enterprise organization using the six standards from the narrowly focused systems listed in Tables 1 and 2.

In light of the preceding discussion, it is clear that it would be desirable to have a method of and system for flexibly integrating the full spectrum of narrowly focused systems listed in Tables 1 and 2 (hereinafter, the narrow systems) with an enterprise level management system while minimizing or eliminating the need for custom interface programming and the use of multiple standards. Ideally, the flexible integration system would integrate the narrow systems within a system for measuring and optimizing the financial performance of a multi-enterprise organization.

### SUMMARY OF THE INVENTION

It is a general object of the present invention to provide a novel and useful system for flexibly integrating all the narrow systems in a multi-enterprise organization in to an overall system for measuring and optimizing financial performance that overcomes the limitations and drawbacks of the existing art that were described previously.

A preferable object to which the present invention is applied is flexibly integrating the systems used for measuring, managing and optimizing the assets, processes, projects and risks associated with the operation of a multi-company commercial organization. Flexible integration is uniquely enabled by five distinct features of the present system:

1) a novel system for classifying all systems by segment of value and element of value for each enterprise;
2) a unique method for identifying the level of analysis contained within the different types of data present in the databases of every enterprise system;
3) a standard for communicating information regarding features (defined in detail later) in a manner that distinguishes them from other data;
4) an innovative technique for separating the four types or classes of risk (element variability, factor variability, event and market risk) within each element of value; and
5) a mechanism for providing financial information to financial service providers.
Information systems work best when they are aligned with the goals of the corporation they serve. Given that the goal of virtually every modern corporation is to improve its financial performance and maximize shareholder value a system for measuring and optimizing financial performance is an ideal framework for flexible enterprise integration.

The flexibility of the enterprise integration system is visible in several ways. First, the system of the present invention requires only the presence of a basic financial system, an advanced financial system, a risk management information system and access to external data to work properly. Thus one aspect of system flexibility is that it will work properly when any number of narrow systems are integrated with it. An important general feature of the system of the innovative system is that its performance improves steadily as more narrow systems are integrated. As systems are added, system flexibility is demonstrated by the fact that there is no specific order in which narrow systems need to be integrated. Another aspect of system flexibility is that the narrow systems do not have to be completely integrated in order to improve the performance of the system. If narrow system operators choose to limit the integration to providing access to data from their system, then the system of the present invention can still function effectively.

Integrating narrow systems to the framework defined by a market value matrix starts by establishing a standard for account numbers, element of value descriptions, enterprise names, external factor descriptions, event risk descriptions and units of measure for the transaction data and descriptive data stored within each of these systems. The organization standard will be used for all data being processed within the system of the present invention so all data extracted for use in the system is first converted to the organization standard (if necessary) before being stored in the application database.

After the organization standard for accounts, elements, factors and units of measure is established, the next stage in system integration is to define the segments of value and elements of value that define the market value matrix. A commercial businesses can create value in five distinct ways:
1. selling products or services that generate positive cash flow;
2. developing real options for generating positive cash flow in the future,
3. holding financial assets that produce income and/or capital gains,
4. holding derivatives of other assets and/or commodities that produce income and/or capital gains, and
5. generating positive market sentiment.
   These five methods for creating value define the segments of enterprise value. When they are added together, the value of these five segments equals the market value of the enterprise.

Separating the segments of value is important for a variety of reasons. Because each segment of value represents a different way to create value, the method for valuing each segment of value is different. The risks associated with each of the segments of value is also very different. For example, financial assets like money in the bank and bonds are far more stable than derivatives that are highly leveraged and can change in value by many orders of magnitude in an instant. Having said that, it is worth noting that most types of risk are present in every segment of value. For example, catastrophic event risk, like the risk of a large hurricane or terrorist attack, can have an impact on all segments of value. In a similar fashion the exposure to external factor variability risk like the risk created by volatile exchange rates can impacts all segments of value. The impact of element variability risk generally has less impact on financial assets and derivatives than the preceding two types of risk. The final type of risk, market sentiment risk is defined as the difference between the overall market risk of the firm's equity (i.e. volatility implied by equity option prices) and the calculated total of the other three types of risk.

Because of the critical importance of the different segments of value. The first step in defining the framework for enterprise system integration is therefore defining the segments of value for the enterprise. The list of the segments of value used in the system of the present invention are shown below in Table 4.

TABLE 4

| Segment Number | Segment Name |
|---|---|
| 10. | Current Operation |
| 11. | Revenue |
| 12. | Expense |
| 13. | Change in Capital |
| 20. | Real Options |
| 21. | Real Option Forecast Revenue |
| 22. | Real Option Expense |
| 23. | Real Option Change in Capital |
| 24. | Forecast Contingent Liability Loss |
| 25. | Contingent Liability Expense |
| 26. | Contingent Liability Change in Capital |
| 30. | Excess Financial Assets |
| 40. | Derivatives |
| 41. | Options |
| 42. | Swaps |
| 43. | Swaptions |
| 44. | Collars |
| 50. | Market Sentiment |

Other segment names and numbers can be used to the same effect. Additional subcategories may also be added to the same effect.

The five segments of value define one axis of the market value matrix. The basic outline of the market value matrix will be completed after we specify the elements of value that define the other axis of the matrix. The list of standard elements of value used in the system of the present invention is shown in table 5.

TABLE 5

| Element Number | Element Name |
|---|---|
| 1. | Segment Total |
| 10. | Financial Assets |
| 11. | Cash |
| 12. | Short Term Assets/Liabilities |
| 13. | Long Term Assets/Liabilities |
| 20. | Tangible Assets |
| 21. | Property |
| 22. | Plant |
| 23. | Systems |
| 24. | Equipment |
| 25. | Land |
| 26. | Infrastructure |
| 30. | Intangible Assets |
| 31. | Brands |
| 32. | Channel Partners |
| 33. | Customers |
| 34. | Employees |
| 35. | Intellectual Property |
| 36. | Investors |
| 37. | Partners |
| 38. | Processes |
| 39. | Suppliers |
| 40. | Going Concern Value |

The segment of value information is used to determine what type of valuation and risk analysis needs to be completed while the element of value designation groups the data for analysis. Using the matrix that has just been defined, the cell or cells in the market value matrix (see FIG. 11) that each of the narrow systems is “managing” can now be specified by designating a segment and an element. For example, the position of a supply chain management system would be defined as shown below:

### Segment of Value: Expense (11), Element of Value: Supplier (38)

If the organization also had a supplier relationship management system, then the data from that system would probably be pointed to the same cell. Projects, processes and risks generally impact more than one element of value so the specifications for systems used to manage these subsets of enterprise operations would be expected to include a designation for more than one element of value. Locating each system within the market value matrix is just the first step in integrating all enterprise systems within a novel system for financial performance measurement and optimization.

The second step in defining the integration framework is refining the placement of information within each cell to distinguish between information related to value and the different types of risk related information. This is done by adding five subcategories to each cell within the market value matrix defined by the segments and elements of value. The five subcategories are shown in Table 6.

TABLE 6
Element subcategories

a. Base Value
b. Element Variability Risk
c. Factor Variability Risk
d. Event Risk
e. Market Volatility Risk

Using the new subcategories, the position of a supply chain management system could be defined more precisely as shown below:

Segment of Value: Expense (11), Element of Value: Supplier (38a, 38b)

This designation would be chosen as the supply chain system has information about the performance of the suppliers. This performance data would be expected to include both standard performance information as well as data regarding variability in performance that may have caused financial distress to the organization. The processing that separates the two subcategories (a and b) from the information provided by the supply chain system will be detailed later in the detailed specification.

Determining a detailed location for each system within the market value matrix is a major step in integrating all enterprise systems into the novel system for financial performance measurement and optimization. The next major step involves identifying what types of data are being received from the integrated systems. There are two types of data that are received from each system: performance data and feature data.

We will discuss feature data first. Features encapsulate all the different options the asset, option, process, project and risk managers have for managing the portion of the organization they are responsible for. For example, factor variability risk associated with fluctuating electricity prices could be minimized by:

1. installing new equipment that reduces the need for electricity;

2. reducing exposure to electricity prices by entering in to long term supply contracts; and/or

3. reducing exposure to electricity prices by purchasing derivatives that “lock-in” price protection for future purchases. These derivatives could include options, swaps, swaptions or collars.

The best choice may be some combination of these 3 different “features”. Feature options (also referred to as options) are options to use a feature in the future. For example, the risk owner could purchase land to install a co-generation plant—giving the enterprise the real option to produce its own electricity at some future date. This real option to produce electricity at a future date could limit the time period which electricity factor variability damaged the enterprise and it would be considered a feature option. As detailed later, the system of the present invention will integrate the enterprise systems as required to select the set of features and feature options that maximize the value and minimize the risk associated with managing the multi-enterprise organization.

For obvious reasons, the fields containing feature data need to be clearly distinguished from the fields containing transaction data and descriptive data. Within the overall feature data classification there are up to five separate values for each feature as shown in Table 7.

TABLE 7
Feature data subcategories

a. Current value (can be yes or no) at system date
b. Maximum value
c. Minimum value
d. time frame to implement
e. cost to implement (capital and expense)
f. Local optimization value and date
g. Enterprise optimization value and date

In general the narrow systems will be providing the system of the present invention with the current value, the range of values (maximum value and minimum value), the time period for implementation and the cost to implement for each feature. The system of the present invention will complete its processing and return the feature set that will optimize the financial performance of the entire enterprise (not just a narrow subset).

Having detailed the method for managing the integration of feature data, we will move on to detail the method for integrating performance data. Performance data includes transaction data and descriptive data. Because many of the systems being integrated have their own analytical capabilities, performance data will also include information derived from transaction data, information derived from descriptive data and information derived from transaction and descriptive data. The derived data would be expected to include: clustered data, statistics regarding the data (trends, standard deviation, covariance, etc.) and performance indicators. The usefulness of the derived data is limited for the same reason the output from these systems is limited - lack of information regarding interaction with other parts of the enterprise and lack of enterprise perspective. However, in some cases the derived data can be used in processing. The use of this derived data eliminates the need for the system of the present invention to repeat the same calculations. Use of the derived data requires an understanding of the type of processing that has been completed. This information is communicated using the categories shown in Table 8.

TABLE 8

Processing Level by Element
a. Raw Data
b. Clustered Data
c. Cluster Criteria
d. Value Driver Candidate (aka performance indicator)
e. Composite Variable
f. Value Driver
g. Independent, Causal Value Driver
h. Combination Factor or Element
i. Vector
j-S#. Value for segment #
k-S#. Element risk for segment #
l-S#. Factor risk for segment #
m-S#. Event risk for segment #
n-S#. Market volatility risk for segment #
Statistics by Element
aa. Mean
ab. Time Period for Mean
ac. Standard Deviation
ad. Time Period for Standard Deviation
ae. Rolling Quarterly Average
af. Time Period for Rolling Quarterly Average
ag. Market Covariance
ah. Time Period for Market Covariance
ai. Slope
aj. Time Period for Slope
ak. Event risk probability
al. Event risk cost

### The categories listed in Table 8 can be expanded as required to cover all the processing completed by the narrow systems.

In addition to using the standard described above for identifying the information obtained from narrow systems, this same standard is used when processing data and storing the results of system processing. As a result, information can be accessed at any point by anyone as required to determine the financial status of the multi-company organization and/or the companies within the organization. We will refer to data that has the economic logic integration identification information attached to it as “tagged data”. Clearly tagging all processed data will facilitate the automated delivery of new financial products and services.

Implementing the economic logic integration method with existing applications can take any of several forms including: pre-programmed templates with specified tag assignments for each application, the use of wizards to guide data tag assignments, extensions to existing xml based standards, the specification of the data tags by the narrow system operators in the data they make available for transfer or some combination of the first four options. In the preferred embodiment, the operators of the narrow systems will include the specified tags in the data they make available for transfer and they will identify the matrix cell or cells that their data pertains to in the information made available to others.

While the preferred embodiment of the novel system for integrating narrow systems in to a financial measurement and optimization system analyzes element impact on all five segments of value, the system can operate when one or more of the segments of value are missing for one or more enterprises and/or for the organization as a whole. For example, the organization may be a value chain that does not have a market value in which case there will be no market sentiment to evaluate. Another common situation would be a multi-company corporation that has no derivatives in most of the enterprises (or companies) within the overall structure. The system is also capable of analyzing a single enterprise. As detailed later, the segments of value that are present in each enterprise are defined in the system settings table (140). Virtually all public companies will have at least three segments of value, current operation, real options and market sentiment. However, it is worth noting only one segment of value is required per enterprise for operation of the system. Because most corporations have only one traded stock, multi-company corporations will generally define an enterprise for the “corporate shell” to account for all market sentiment. This “corporate shell” enterprise can also be used to account for any joint options the different companies within the corporation may collectively possess. The system is also capable of analyzing the value of the organization without considering all types of risk. However, the system needs to complete the value analysis before it can complete the analysis of all organization risks.

The innovative system has the added benefit of providing a large amount of detailed information to the organization users concerning both tangible and intangible elements of value by enterprise. Because intangible elements are by definition not tangible, they can not be measured directly. They must instead be measured by the impact they have on their surrounding environment. There are analogies in the physical world. For example, electricity is an “intangible” that is measured by the impact it has on the surrounding environment. Specifically, the strength of the magnetic field generated by the flow of electricity through a conductor turns a motor and the motion of this motor is used to determine the amount of electricity that is being consumed.
The system of the present invention measures intangible elements of value by identifying the attributes that, like the magnetic field, reflect the strength of the element in driving segments of value (current operation, excess financial assets, real options, derivatives, market sentiment) and/or components of value (revenue, expense and change in capital) within the current operation and are relatively easy to measure. Once the attributes related to the strength of each element are identified, they can be summarized into a single expression (a composite variable or vector) if the attributes don't interact with attributes from other elements. If attributes from one element drive those from another, then the elements can be combined for analysis and/or the impact of the individual attributes can be summed together to calculate a value for the element. In the preferred embodiment, vectors are used to summarize the impact of the element attributes. The vectors for all elements are then evaluated to determine their relative contribution to driving each of the components of value and/or each of the segments of value. The system of the present invention calculates the product of the relative contribution and the forecast longevity of each element to determine the relative contribution to each of the components of value to an overal value. The contribution of each element to each component of value are then added together to determine the value of the current operation contribution of each element (see Table 5). The contribution of each element to the enterprise is then determined by summing the element contribution to each segment of value. The organization value is then calculated by summing the value all the enterprises within the organization

In accordance with the invention, the automated extraction of data from existing narrow systems significantly increases the scale and scope of the analysis that can be completed. The system of the present invention further enhances the efficiency and effectiveness of the analysis by automating the retrieval, storage and analysis of information useful for analyzing elements of value, segments of value and organization risks from external databases, external publications and the Internet. To facilitate its use as a tool for financial management, the system of the present invention produces intuitive graphical reports and reports in formats that are similar to the reports provided by traditional accounting systems. Integrating information from all enterprise systems is just one way the system of the present invention overcomes the limitations of existing methods and systems.

The method for integrating the numerous, narrow business management systems provided by the present invention eliminates the need for custom interface development. It also eliminates the need to use six different standards in operating an enterprise wide financial management system. Most importantly the system of the present invention completely integrates all of the narrowly focused enterprise systems in to an overall system for measuring and optimizing organizational financial performance. The level of integration enabled by the system of the present invention will also support: the creation of new financial products; the creation of new financial services; the automated delivery of new financial products and services; the automated delivery of traditional financial products and services; and the integration of narrow systems with other applications.

By providing real-time financial insight to users of every system in the organization, the integrated system of the present invention enables the continuous optimization of management decision making across an entire multi-enterprise organization.

### BRIEF DESCRIPTION OF DRAWINGS

These and other objects, features and advantages of the present invention will be more readily apparent from the following description of the preferred embodiment of the invention in which:

FIG. 1 is a block diagram showing the major processing steps of the present invention;

FIG. 2 is a diagram showing the files or tables in the application database (50) of the present invention that are utilized for data storage and retrieval during the processing in the innovative system for multi-enterprise organization analysis and optimization;

FIG. 3 is a block diagram of an implementation of the present invention;

FIG. 4 is a block diagrams showing the sequence of steps in the present invention used for specifying system settings and for integrating with other systems;

FIG. 5A, FIG. 5B and FIG. 5C are block diagrams showing the sequence of steps in the present invention used for preparing data obtained from the narrow systems for processing by the system of the present invention;

FIG. 6A, FIG. 6B and FIG. 6C are block diagrams showing the sequence of steps in the present invention used for creating the market value matrix for the organization by enterprise;

FIG. 7 is a block diagram showing the sequence of steps in the present invention used for determining the optimized mode to operate the organization under a variety of scenarios;

FIG. 8 is a block diagram showing the sequence in steps in the present invention used in defining and displaying reports and completing special analyses;

FIG. 9 is a diagram showing the data windows that are used for receiving information from and transmitting information to the user (20) during system processing;

FIG. 10 is a diagram showing how the enterprise matrices of risk can be combined to calculate the organizational matrix of risk; and

FIG. 11 is a diagram showing how the enterprise market value matrices can be combined to calculate the market value matrix for the organization;

FIG. 12 is a sample report showing the efficient frontier for Organization XYZ and the current position of XYZ relative to the efficient frontier and the market frontier; and

FIG. 13 is a sample report showing the efficient frontier for Organization XYZ, the current position of XYZ relative to the efficient frontier and the forecast of the new position of XYZ relative to the efficient frontier after user specified changes are implemented.

### DETAILED DESCRIPTION OF THE PREFERRED EMBODIMENT

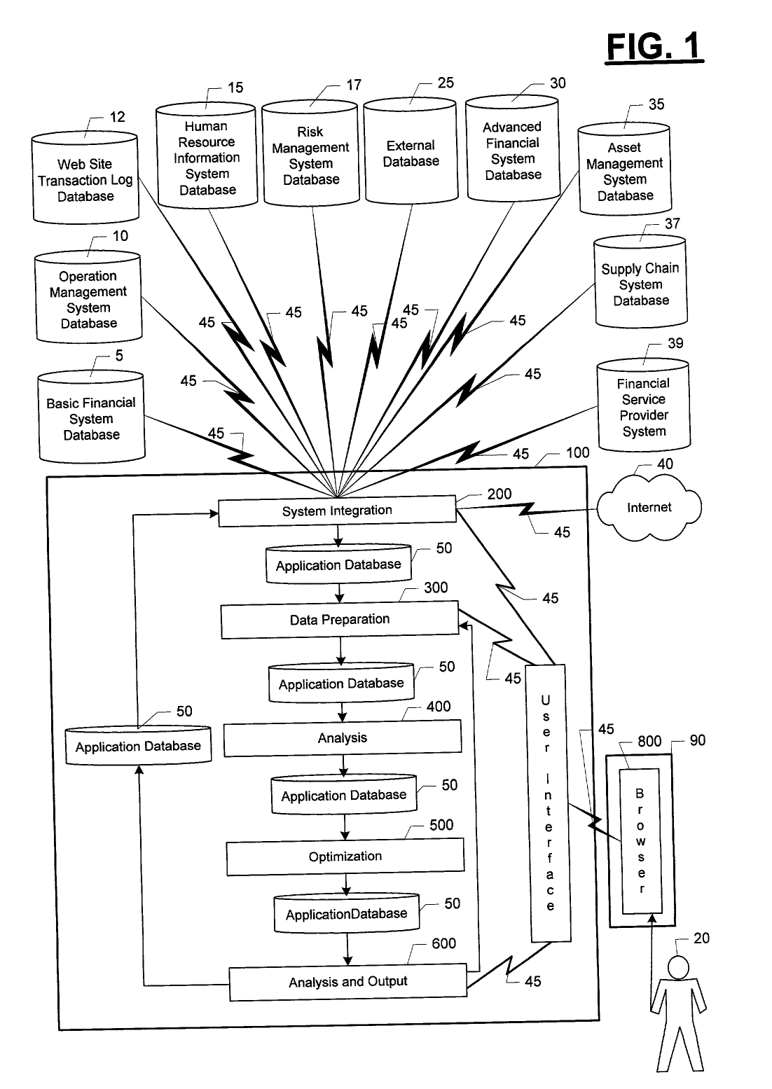

FIG. 1 provides an overview of the processing completed by the innovative system for defining, measuring and continuously optimizing the market value matrix for a multi-enterprise organization. In accordance with the present invention, an automated method of and system (100) for producing the optimal market value matrix for a multi-enterprise commercial organization is provided. Processing starts in this system (100) with the specification of system settings and the flexible integration (200) of the system of the present invention with the basic financial system, operation management system, web site management system, human resource management system, risk management system, external database, asset management system, supply chain system and financial service provider system via a network (45). The system integration progress may be influenced by a user (20) through interaction with a user-interface portion of the application software (700) that mediates the display, transmission and receipt of all information to and from browser software (800) such as the Netscape Navigator or the Microsoft Internet Explorer in an access device (90) such as a phone, pda or personal computer where data is entered by the user (20).

While only one system and database of each type (5, 10, 12, 15, 17, 25, 30, 35, 37 and 39) is shown in FIG. 1, it is to be understood that the system (100) can integrate with all narrow systems listed in Tables 1 and 2. In the preferred embodiment at least one system of each type listed (5, 10, 12, 15, 17, 25, 30, 35, 37 and 39) will be integrated with the system (100) via the network (45) for each enterprise within the organization. While the data from multiple asset management systems can be utilized in the analysis of each element of value completed by the system of the present invention, the preferred embodiment of the present invention contains only one asset management system for each element of value being analyzed for each enterprise within the organization. Integrating all the asset management systems ensures that every asset—tangible or intangible—is considered within the overall financial framework for the organization. It should also be understood that it is possible to complete a bulk extraction of data from each database (5, 10, 12, 15, 17, 25, 30, 35, 37 and 39) and the Internet 40 via the network (45) using peer to peer networking and data extraction applications before initializing the data bots. The data extracted in bulk could be stored in a single datamart, a data warehouse or a storage area network where the data bots could operate on the aggregated data or the data could be left in the original databases and extracted as needed for calculations by the bots over a network (45).

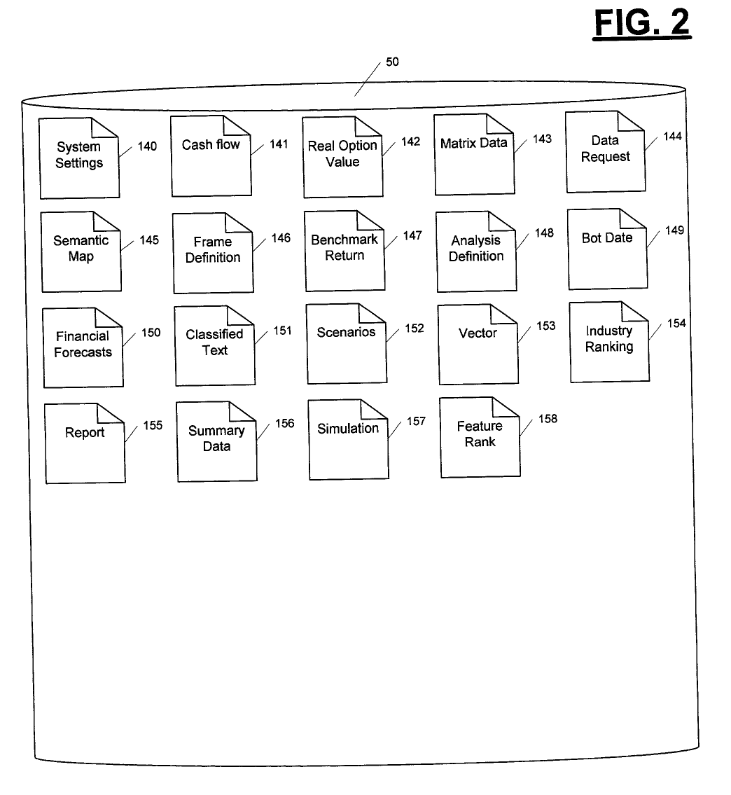

All extracted information is stored in a file or table (hereinafter, table) within an application database (50) as shown in FIG. 2. The application database (50) contains tables for storing user input, extracted information and system calculations including a system settings table (140), a cash flow table (141), a real option value table (142), a matrix data table (143), a data request table (144), a semantic map table (145), a frame definition table (146), a benchmark return table (147), an analysis definition table (148), a bot date table (149), a financial forecasts table (150), a classified text table (151), a scenarios table (152), a vector table (153), an industry ranking table (154), a report table (155), an summary data table (156), a simulation table (157) and a feature rank table (158).

The application database (50) can optionally exist as a datamart, data warehouse or storage area network. The system of the present invention has the ability to accept and store supplemental or primary data directly from user input, a data warehouse or other electronic files in addition to receiving data from the databases described previously. The system of the present invention also has the ability to complete the necessary calculations without receiving data from one or more of the specified databases. However, in the preferred embodiment all required information is obtained from the specified data sources (5, 10, 12, 15, 17, 25, 30, 35, 37, 39 and 40) for each enterprise in the organization.

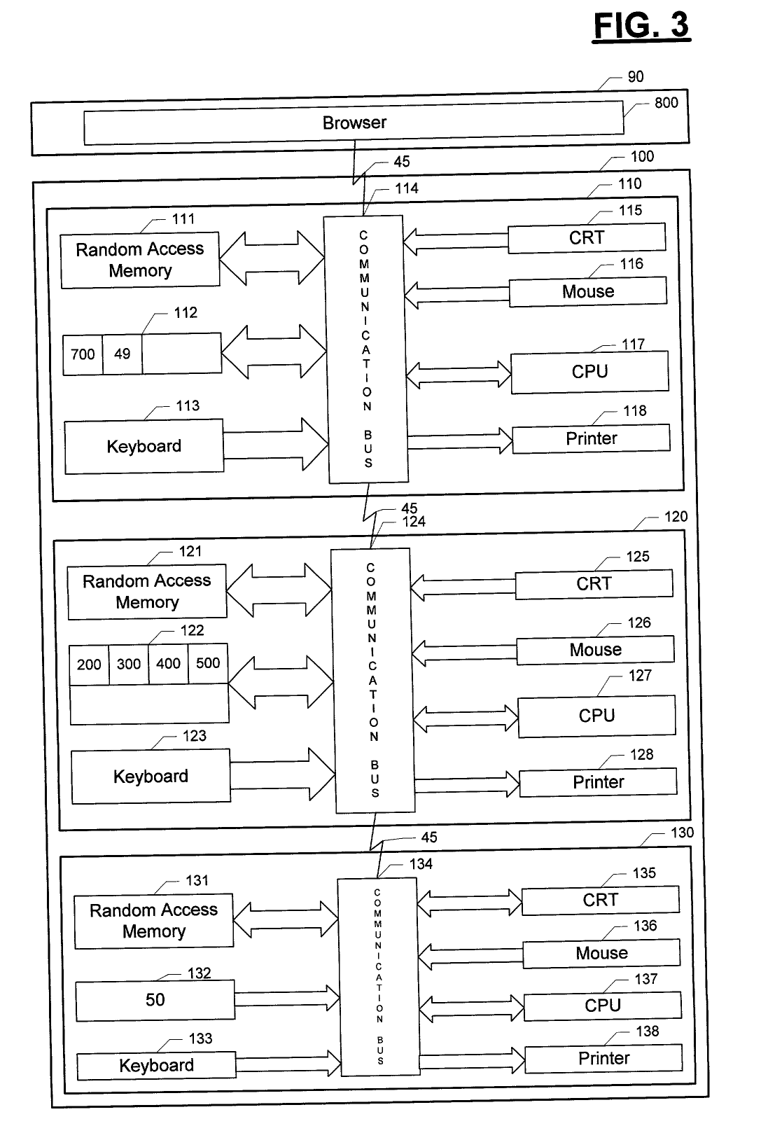

As shown in FIG. 3, the preferred embodiment of the present invention is a computer system (100) illustratively comprised of a user-interface personal computer (110) connected to an application-server personal computer (120) via a network (45). The application server personal computer (120) is in turn connected via the network (45) to a database-server personal computer (130). The user interface personal computer (110) is also connected via the network (45) to an Internet browser appliance (90) that contains browser software (800) such as Microsoft Internet Explorer or Netscape Navigator.

The database-server personal computer (130) has a read/write random access memory (131), a hard drive (132) for storage of the application database (50), a keyboard (133), a communications bus (134), a display (135), a mouse (136), a CPU (137) and a printer (138).

The application-server personal computer (120) has a read/write random access memory (121), a hard drive (122) for storage of the non-user-interface portion of the enterprise section of the application software (200, 300, 400, 500 and 600) of the present invention, a keyboard (123), a communications bus (124), a display (125), a mouse (126), a CPU (127) and a printer (128). While only one client personal computer is shown in FIG. 3, it is to be understood that the application-server personal computer (120) can be networked to fifty or more client, user-interface personal computers (110) via the network (45). The application-server personal computer (120) can also be networked to fifty or more server, personal computers (130) via the network (45). It is to be understood that the diagram of FIG. 3 is merely illustrative of one embodiment of the present invention. The user-interface personal computer (110) has a read/write random access memory (111), a hard drive (112) for storage of a client data-base (49) and the user-interface portion of the application software (700), a keyboard (113), a communications bus (114), a display (115), a mouse (116), a CPU (117) and a printer (118).

The application software (200, 300, 400, 500 and 600) controls the performance of the central processing unit (127) as it completes the calculations required to support the production of the matrices of value and risk for a commercial enterprise. In the embodiment illustrated herein, the application software program (200, 300, 400, 500 and 600 is written in a combination of C++, Java and Visual Basic®. The application software (200, 300, 400, 500, and 600) can use Structured Query Language (SQL) for extracting data from the databases and the Internet (5, 10, 12, 15, 17, 25, 30, 35, 37 and 40). The user (20) can optionally interact with the user-interface portion of the application software (700) using the browser software (800) in the browser appliance (90) to provide information to the application software (200, 300, 400, 500 and 600) for use in determining which data will be extracted and transferred to the application database (50) by the data bots.

User input is initially saved to the client database (49) before being transmitted to the communication bus (124) and on to the hard drive (122) of the application-server computer via the network (45). Following the program instructions of the application software, the central processing unit (127) accesses the extracted data and user input by retrieving it from the hard drive (122) using the random access memory (121) as computation workspace in a manner that is well known.

The computers (110, 120, 130) shown in FIG. 3 illustratively are personal computers or workstations that are widely available. Typical memory configurations for client personal computers (110) used with the present invention should include at least 512 megabytes of semiconductor random access memory (111) and at least a 100 gigabyte hard drive (112). Typical memory configurations for the application-server personal computer (120) used with the present invention should include at least 2056 megabytes of semiconductor random access memory (121) and at least a 250 gigabyte hard drive (122). Typical memory configurations for the database-server personal computer (130) used with the present invention should include at least 4112 megabytes of semiconductor random access memory (131) and at least a 500 gigabyte hard drive (132).

Using the system described above the market value matrix is used as a template to guide the integration of the narrowly focused enterprise systems in to a system for measuring and optimizing the financial performance of a multi-enterprise organization.

In the preferred embodiment, the revenue, expense and capital requirement forecasts for the current operation, the real options and the contingent liabilities are obtained from an advanced financial planning system database (30) derived from an advanced financial planning system similar to the one disclosed in U.S. Pat. No. 5,615,109. The extracted revenue, expense and capital requirement forecasts are used to calculate a cash flow for each period covered by the forecast for each enterprise by subtracting the expense and change in capital for each period from the revenue for each period. A steady state forecast for future periods is calculated after determining the steady state growth rate that best fits the calculated cash flow for the forecast time period. The steady state growth rate is used to calculate an extended cash flow forecast. The extended cash flow forecast is used to determine the Competitive Advantage Period (CAP) implicit in the enterprise market value.

For the calculations completed by the present invention, a transaction will be defined as any event that is logged or recorded. Transaction data is any data related to a transaction. Descriptive data is any data related to any item, segment of value, element of value, component of value or external factor that is logged or recorded. Descriptive data includes forecast data and other data calculated by the system of the present invention. An element of value will be defined as “an entity or group that as a result of past transactions, forecasts or other data has provided and/or is expected to provide economic benefit to the enterprise.” An item will be defined as a single member of the group that defines an element of value. For example, an individual salesman would be an “item” in the “element of value” sales staff. It is possible to have only one item in an element of value. The transaction data and descriptive data associated with an item or related group of items will be referred to as “item variables”. Data derived from transaction data and/or descriptive data are referred to as an item performance indicators. Composite variables for an element are mathematical or logical combinations of item variables and/or item performance indicators. The item variables, item performance indicators and composite variables for a specific element or sub-element of value can be referred to as element variables or element data. External factors are numerical indicators of: conditions or prices external to the enterprise and conditions or performance of the enterprise compared to external expectations of conditions or performance. The transaction data and descriptive data associated with external factors will be referred to as “factor variables”. Data derived from factor transaction data and/or descriptive data are referred to as factor performance indicators. Composite factors for a factor are mathematical or logical combinations of factor variables and/or factor performance indicators. The factor variables, factor performance indicators and composite factors for external factors can be referred to as factor data.

A value chain is defined to be the enterprises that have joined together to deliver a product and/or a service to a customer. An enterprise is a commercial enterprise with one revenue component of value (note: a commercial enterprise can have more than one revenue component of value). A multi company corporation is a corporation that participates in more than one distinct line of business. The distinctiveness of a given line of business is determined by the elements of value that support the business. If more than 50% of the elements of value that support a revenue stream are unique to that revenue stream, then that revenue stream defines a “distinct” line of business. As discussed previously, value chains and multi-company corporations are both multi-enterprise organizations. Partnerships between government agencies and private companies and/or other government agencies can also be analyzed as multi-enterprise organizations using the system of the present invention.

Risk is defined as events or variability that may cause losses and/or diminished financial performance for an enterprise or organization. There are a wide variety of sources for each type of the two major types of risk—variability risk and event risk. In general, variability risk is caused by external factors (i.e. commodity prices, interest rates, exchange rates, popular ideas, market level, etc.) and elements of value (i.e. processes, equipment, employees, etc.). There is also variability associated with the price of equity in a company. The implied amount of this variability can be determined by examining the option prices for company equity. We will refer to the first type of variability risk as factor variability risk or factor variability. The second type of variability risk will be referred to as element variability risk or element variability. The implied variability associated with equity will be referred to as market variability risk or market variability. In all cases, variability risk is quantified using statistical measures like standard deviation per month, year or some other time period. The covariance between different variability risks is also determined as simulations require quantified information regarding the inter-relationship between the different risks to perform effectively. The other major class of risk is event risk. Most insurance policies cover event risks. For example, an insurance policy might state in essence that: if this event happens, then we will reimburse event related expenses up to a pre-determined amount. Event risks are typically associated with damage to people and property that are caused by accidents, the weather (hurricanes, tornadoes) and acts of nature (earthquakes, volcanoes, etc.). Event risks are generally tracked by insurance companies and their insured clients using modified database programs that keep track of each occurrence of each type of risk, its cause, cost and the amount of money that was reimbursed. These programs can be used to analyze historical patterns and develop forecasts. The forecasts are often used in forecasting the expected frequency of different events, the cost associated with each event and the associated dollar value of the risk that should be insured. The final category of risk, market risk, is the different between market variability risk and the sum of all calculated variability risks and event risks.

Analysis bots are used to determine element of value lives and the percentage of each segment of value that is attributable to each element of value by enterprise. The resulting values are then added together to determine the valuation for each element. This process is illustrated by the example in Table 9 for the current operation segment of value (which is divided in to 3 components of value—revenue, expense and capital change for more detailed analysis).

TABLE 9

| | | Element | |
|---|---|---|---|
| Gross Value | Percentage | Life/CAP* | Net Value |
| Revenue value = $120M | 20% | 80% | Value = $19.2 M |
| Expense value = ($80M) | 10% | 80% | Value = ($6.4) M |
| Capital value = ($5M) | 5% | 80% | Value = ($0.2) M |
| Total value = $35M | | | |

| | |
|---|---|
| Net value for this element: | Value = $12.6 M |

*CAP = Competitive Advantage Period

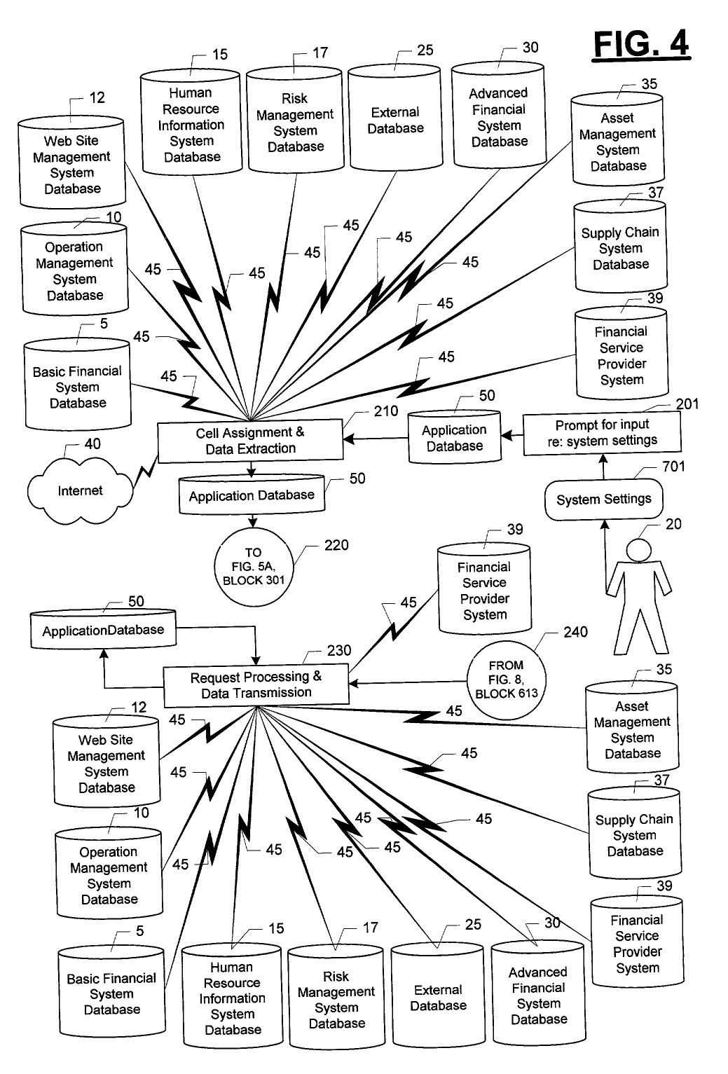

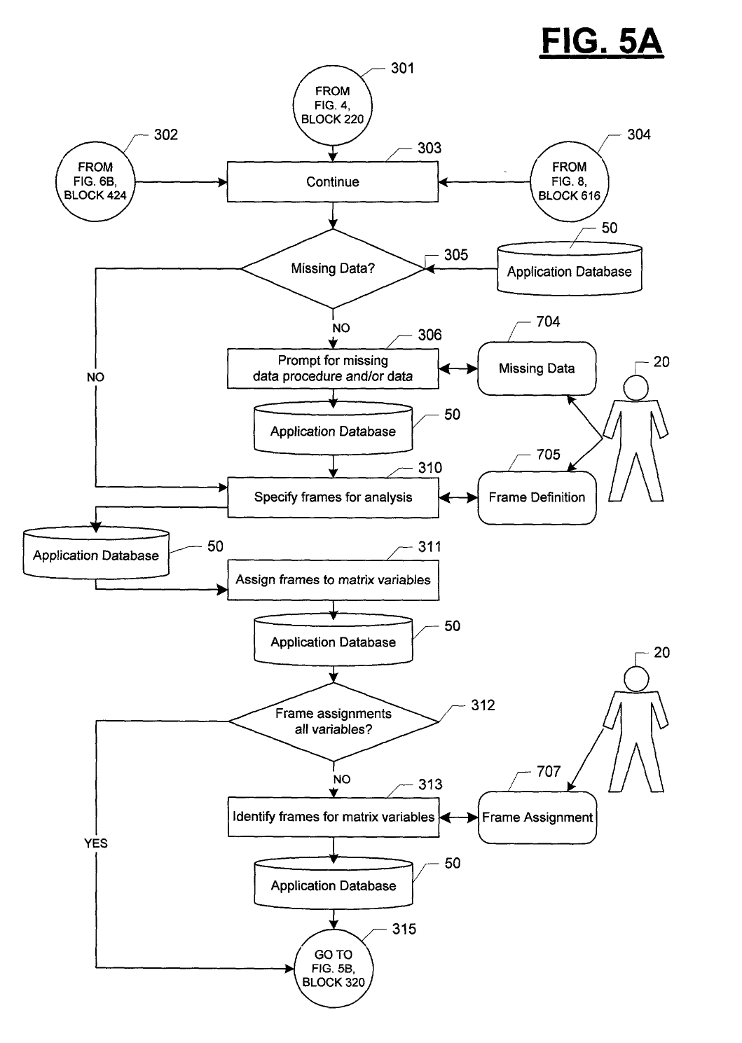

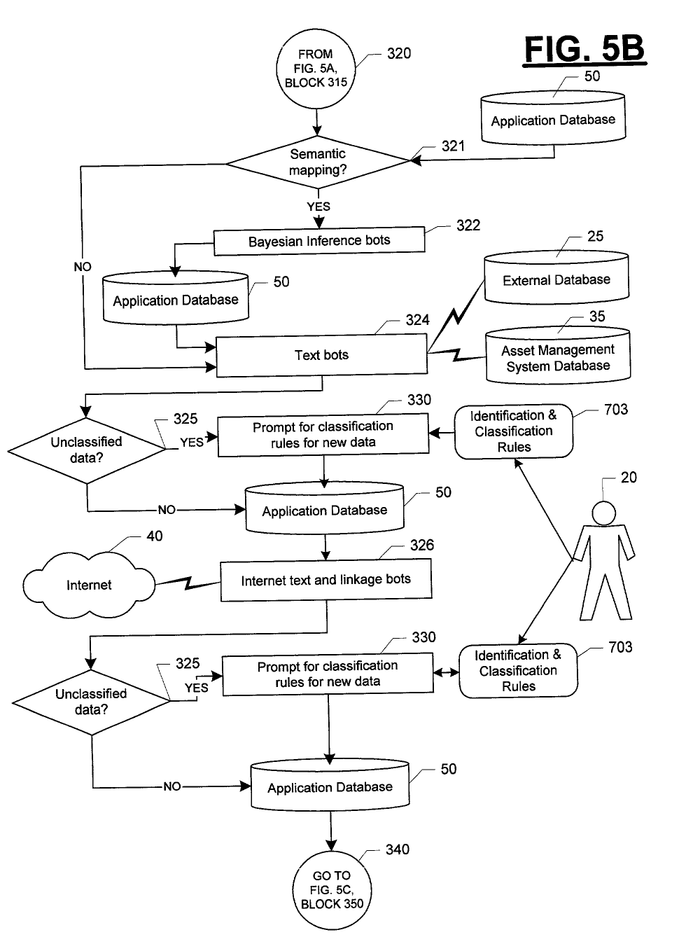

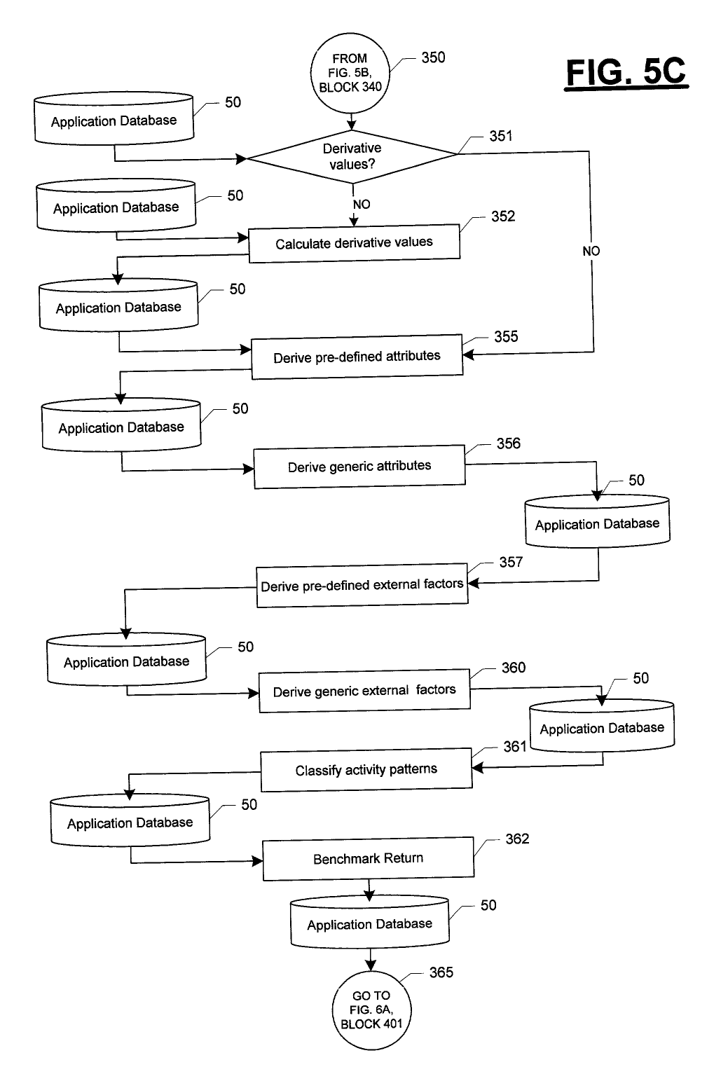

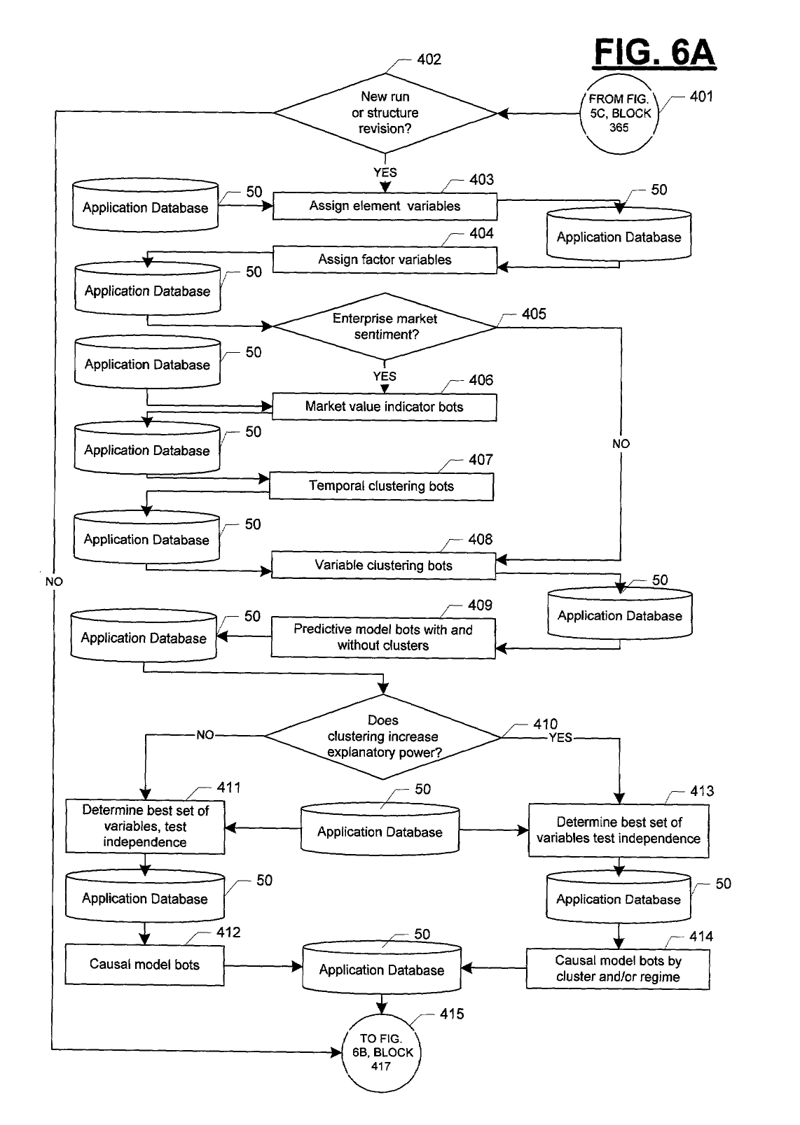

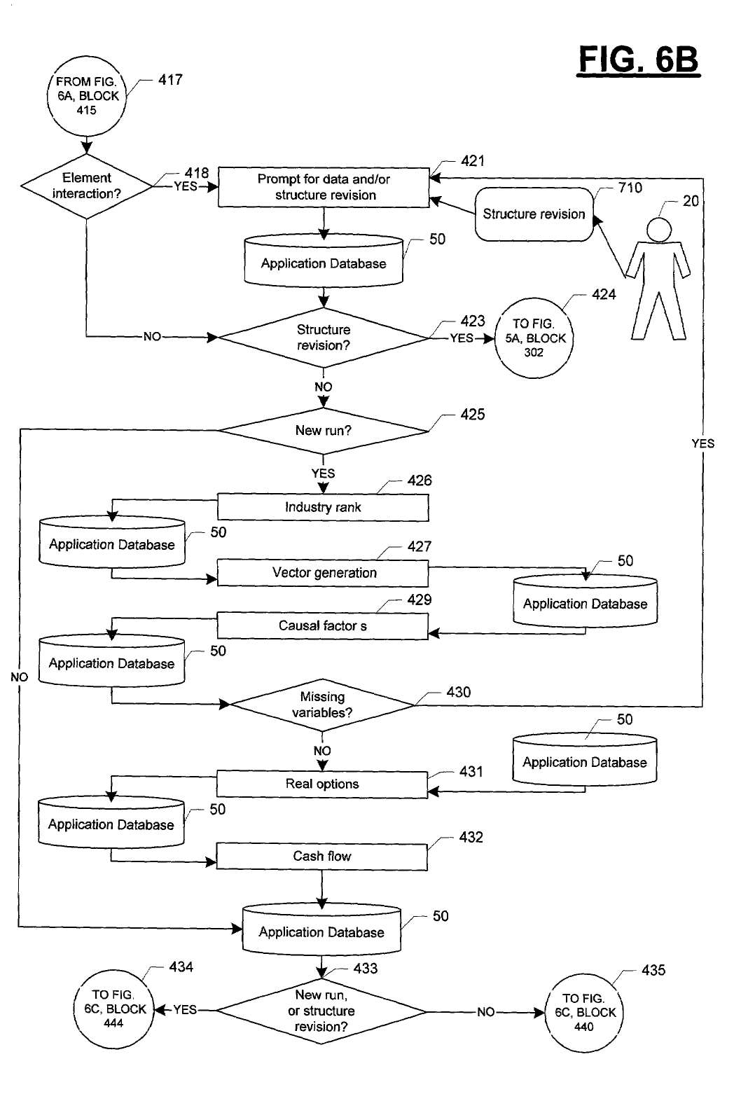

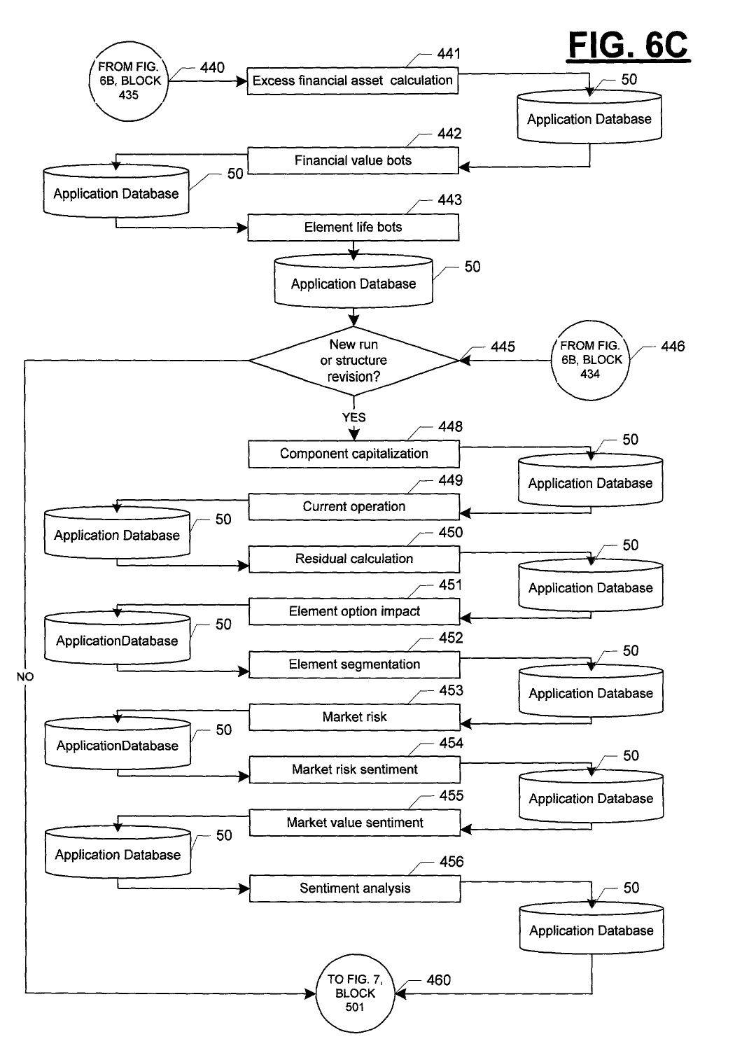

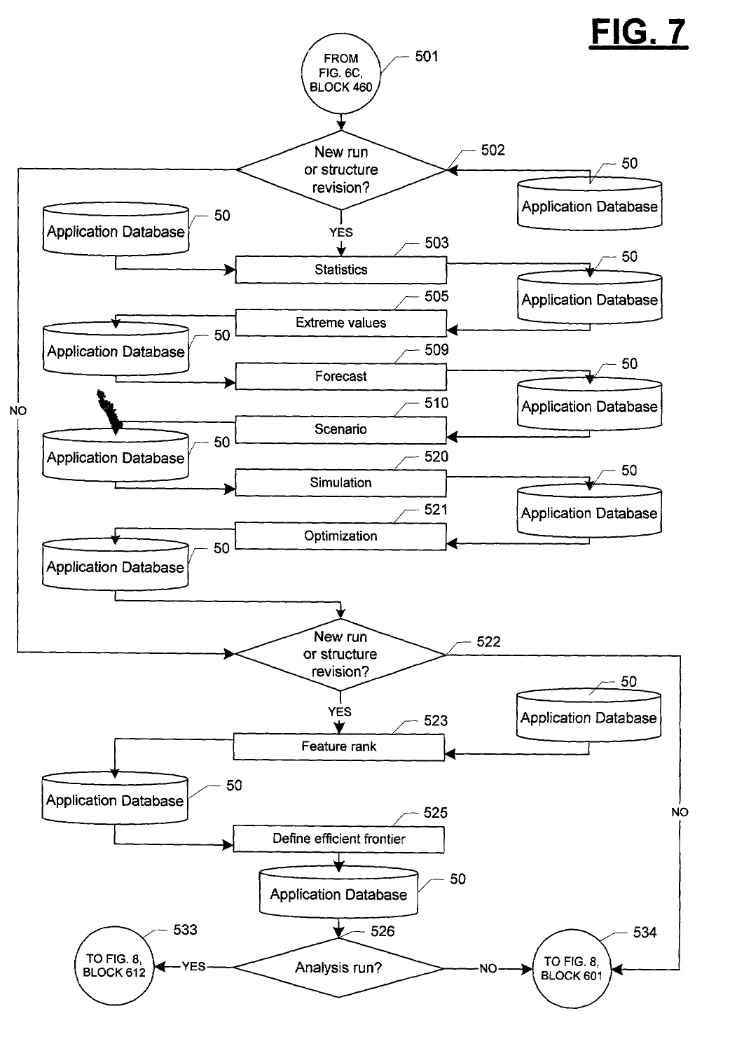

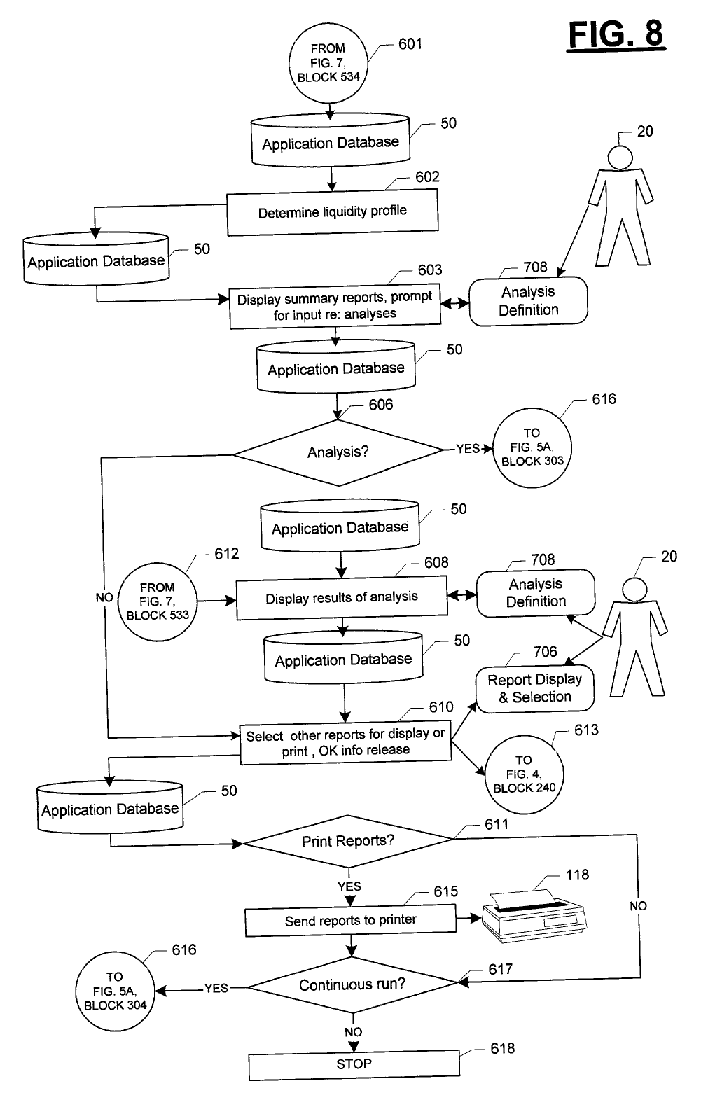

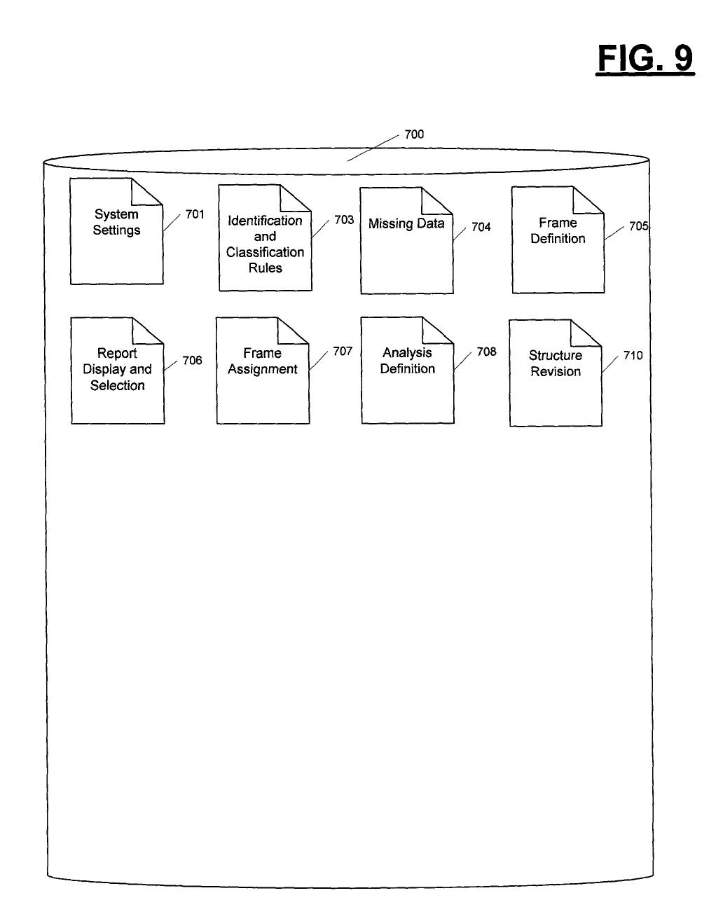

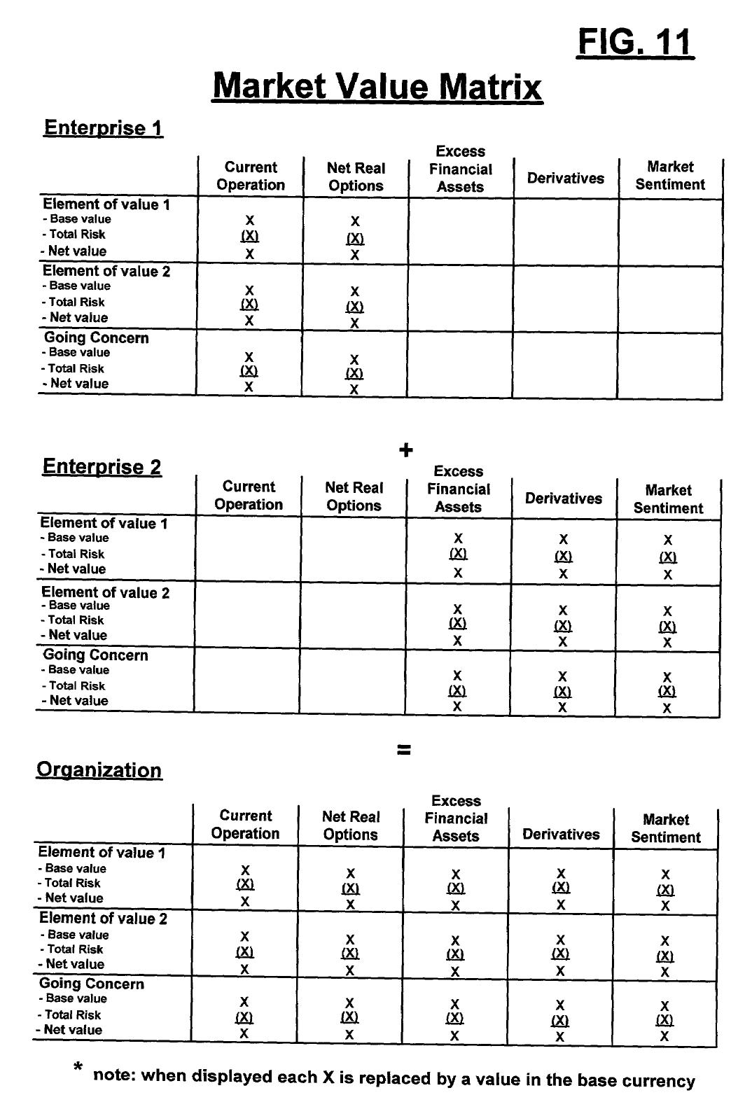

The integration of the different systems in to an overall financial measurement and optimization system for the multi-enterprise organization is completed in five distinct stages. As shown in FIG. 4, (block 200 from FIG. 1) the first stage of processing integrates the system of the present invention with the other systems within each enterprise of the multi-enterprise organization. This integration facilitates the extraction of required data and the return of optimized feature sets to the integrated systems for implementation. As shown in FIG. 5A, FIG. 5B and FIG. 5C, the second stage of processing (block 300 from FIG. 1) prepares data from the narrow systems for the analysis of business value and risk by enterprise. As shown in FIG. 6A, FIG. 6B and FIG. 6C the third stage of processing (block 400 from FIG. 1) continually generates the market value matrix quantifying the impact of elements of value, external factors and event risks on the segments of value by enterprise (see FIG. 11). The fourth stage of processing (block 500 from FIG. 1), shown in FIG. 7, defines the optimal feature set for the organization and identifies the efficient frontier for financial performance under a variety of scenarios. As shown in FIG. 8, the fifth stage of processing (block 600 from FIG. 1) displays the market value matrix and the efficient frontier for the organization and analyzes the impact of changes in structure and/or operation on the financial performance of the multi-enterprise organization. If the operation is continuous, then processing loops back to stage two and repeats the processing described above.

### System Integration

The flow diagram in FIG. 4 details the processing that is completed by the portion of the application software (200) that integrates with other applications as required to support organization financial measurement and optimization. As discussed previously, the system of the present invention is capable of integrating the narrowly focused systems listed in Tables 1 and 2. Operation of the system (100) is illustrated by describing the integration of the system (100) with the basic financial system, the operation management system, the web site management system, the human resource system, the risk management system, an external database an advanced financial system, an asset management system, and a supply chain system. Communications are completed between the system of the present invention and the: basic financial system database (5), operation management system database (10), web site management system database (12), human resource information system database (15), risk management system database (17), external database (25), advanced financial system database (30), asset management system database (35), supply chain system database (37), financial service provider system (39) and the Internet (40) by enterprise. A brief overview of the different systems will be presented before reviewing each step of processing completed by this portion (200) of the application software.

Corporate financial software systems are generally divided into two categories, basic and advanced. Advanced financial systems utilize information from the basic financial systems to perform financial analysis, financial forecasting, financial planning and financial reporting functions. Virtually every commercial enterprise uses some type of basic financial system as they are generally required to use these systems to maintain books and records for income tax purposes. An increasingly large percentage of these basic financial systems are resident in computer systems and intranets. Basic financial systems include general-ledger accounting systems with associated accounts receivable, accounts payable, capital asset, inventory, invoicing, payroll and purchasing subsystems. These systems incorporate worksheets, files, tables and databases. These databases, tables and files contain information about the enterprise operations and its related accounting transactions. As will be detailed below, these databases, tables and files are accessed by the application software of the present invention as required to extract the information required for enterprise measurement and optimization. The system is also capable of extracting the required information from a data warehouse (or datamart) when the required information has been loaded into the warehouse.

General ledger accounting systems generally store only valid accounting transactions. As is well known, valid accounting transactions consist of a debit component and a credit component where the absolute value of the debit component is equal to the absolute value of the credit component. The debits and the credits are posted to the separate accounts maintained within the accounting system. Every basic accounting system has several different types of accounts. The effect that the posted debits and credits have on the different accounts depends on the account type as shown in Table 10.

TABLE 10

| Account Type: | Debit Impact: | Credit Impact: |
|---|---|---|
| Asset | Increase | Decrease |
| Revenue | Decrease | Increase |
| Expense | Increase | Decrease |
| Liability | Decrease | Increase |
| Equity | Decrease | Increase |

### General ledger accounting systems also require that the asset account balances equal the sum of the liability account balances and equity account balances at all times.

The general ledger system generally maintains summary, dollar only transaction histories and balances for all accounts while the associated subsystems, accounts payable, accounts receivable, inventory, invoicing, payroll and purchasing, maintain more detailed historical transaction data and balances for their respective accounts. It is common practice for each subsystem to maintain the detailed information shown in Table 11 for each transaction.

TABLE 11

| Subsystem | Detailed Information |
|---|---|
| Accounts | Vendor, Item(s), Transaction Date, Amount Owed, Due |
| Payable | Date, Account Number |
| Accounts | Customer, Transaction Date, Product Sold, Quantity, Price, |
| Receivable | Amount Due, Terms, Due Date, Account Number |
| Capital | Asset ID, Asset Type, Date of Purchase, Purchase Price, |
| Assets | Useful Life, Depreciation Schedule, Salvage Value |
| Inventory | Item Number, Transaction Date, Transaction Type, |
| | Transaction Qty, Location, Account Number |
| Invoicing | Customer Name, Transaction Date, Product(s) Sold, |
| | Amount Due, Due Date, Account Number |
| Payroll | Employee Name, Employee Title, Pay Frequency, Pay |
| | Rate, Account Number |
| Purchasing | Vendor, Item(s), Purchase Quantity, Purchase Price(s), |
| | Due Date, Account Number |

As is well known, the output from a general ledger system includes income statements, balance sheets and cash flow statements in well defined formats which assist management in measuring the financial performance of the firm during the prior periods when data input and system processing have been completed.

While basic financial systems are similar between firms, operation management systems vary widely depending on the type of company they are supporting. These systems typically have the ability to not only track historical transactions but to forecast future performance. For manufacturing firms, operation management systems such as Enterprise Resource Planning Systems (ERP), Material Requirement Planning Systems (MRP), Purchasing Systems, Scheduling Systems and Quality Control Systems are used to monitor, coordinate, track and plan the transformation of materials and labor into products. Systems similar to the one described above may also be useful for distributors to use in monitoring the flow of products from a manufacturer.

Operation Management Systems in manufacturing firms may also monitor information relating to the production rates and the performance of individual production workers, production lines, work centers, production teams and pieces of production equipment including the information shown in Table 12.

TABLE 12
Operation Management System - Production Information

```
  1. ID number (employee id/machine id)
  2. Actual hours - last batch
  3. Standard hours - last batch
  4. Actual hours - year to date
  5. Actual/Standard hours - year to date %
  6. Actual setup time - last batch
  7. Standard setup time - last batch
  8. Actual setup hours - year to date
  9. Actual/Standard setup hrs - yr to date %
10. Cumulative training time
11. Job(s) certifications
12. Actual scrap - last batch
13. Scrap allowance - last batch
14. Actual scrap/allowance - year to date
15. Rework time/unit last batch
16. Rework time/unit year to date
17. QC rejection rate - batch
18. QC rejection rate - year to date
```

Operation management systems are also useful for tracking requests for service to repair equipment in the field or in a centralized repair facility. Such systems generally store information similar to that shown below in Table 13.

TABLE 13
Operation Management System - Service Call Information

```
  1. Customer name
  2. Customer number
  3. Contract number
  4. Service call number
  5. Time call received
  6. Product(s) being fixed
  7. Serial number of equipment
  8. Name of person placing call
  9. Name of person accepting call
10. Promised response time
11. Promised type of response
12. Time person dispatched to call
13. Name of person handling call
14. Time of arrival on site
15. Time of repair completion
16. Actual response type
17. Part(s) replaced
18. Part(s) repaired
19. 2nd call required
20. 2nd call number
```

Web site management system databases keep a detailed record of every visit to a web site, they can be used to trace the path of each visitor to the web site and upon further analysis can be used to identify patterns that are most likely to result in purchases and those that are most likely to result in abandonment. This information can also be used to identify which promotion would generate the most value for the enterprise using the system. Web site management systems generally contain the information shown in Table 14.

TABLE 14
Web site management system database

```
  1. Customer's URL
  2. Date and time of visit
  3. Pages visited
  4. Length of page visit (time)
  5. Type of browser used
  6. Referring site
  7. URL of site visited next
  8. Downloaded file volume and type
  9. Cookies
10. Transactions
```

Computer based human resource systems may some times be packaged or bundled within enterprise resource planning systems such as those available from SAP, Oracle and Peoplesoft. Human resource systems are increasingly used for storing and maintaining corporate records concerning active employees in sales, operations and the other functional specialties that exist within a modern corporation. Storing records in a centralized system facilitates timely, accurate reporting of overall manpower statistics to the corporate management groups and the various government agencies that require periodic updates. In some cases, human resource systems include the enterprise payroll system as a subsystem. In the preferred embodiment of the present invention, the payroll system is part of the basic financial system. These systems can also be used for detailed planning regarding future manpower requirements. Human resource systems typically incorporate worksheets, files, tables and databases that contain information about the current and future employees. As will be detailed below, these databases, tables and files are accessed by the application software of the present invention as required to extract the information required for completing a business valuation. It is common practice for human resource systems to store the information shown in Table 15 for each employee.

TABLE 15
Human Resource System Information

```
  1. Employee name
  2. Job title
  3. Job code
  4. Rating
  5. Division
  6. Department
  7. Employee No./(Social Security Number)
  8. Year to date - hours paid
  9. Year to date - hours worked
10. Employee start date - enterprise
11. Employee start date - department
12. Employee start date - current job
13. Training courses completed
14. Cumulative training expenditures
15. Salary history
16. Current salary
17. Educational background
18. Current supervisor
```

Risk management systems databases (17) contain statistical data about the past behavior and forecasts of likely future behavior of interest rates, currency exchange rates weather, commodity prices and key customers (credit risk systems). They also contain detailed information about the composition and mix of risk reduction products (derivatives, insurance, etc.) the enterprise has purchased. Some companies also use risk management systems to evaluate the desirability of extending or increasing credit lines to customers. The information from these systems is used to supplement the risk information developed by the system of the present invention.

External databases can be used for obtaining information that enables the definition and evaluation of a variety of things including elements of value, external factors, industry real options and event risks. In some cases, information from these databases can be used to supplement information obtained from the other databases and the Internet (5, 10, 12, 15, 17, 30, 35, 37, 39 and 40). In the system of the present invention, the information extracted from external databases (25) includes the data listed in Table 16.

TABLE 16
Types of information

1) numeric information such as that found in the SEC Edgar database and
the databases of financial infomediaries such as FirstCall, IBES and
Compustat,
2) text information such as that found in the Lexis Nexis database and
databases containing past issues from specific publications,
3) risk management products such as derivatives, swaps and standardized
insurance contracts that can be purchased on line,
4) geospatial data;
5) multimedia information such as video and audio clips, and
6) event risk data including information about the likelihood of a loss and
the magnitude of such a loss

The system of the present invention uses different “bot” types to process each distinct data type from external databases (25). The same “bot types” are also used for extracting each of the different types of data from the Internet (40). The system of the present invention must have access to at least one data source (usually, an external database (25)) that provides information regarding the equity prices for each enterprise and the equity prices and financial performance of the competitors for each enterprise.

Advanced financial systems may also use information from external databases (25) and the Internet (40) in completing their processing. Advanced financial systems include financial planning systems and activity based costing systems. Activity based costing systems may be used to supplement or displace the operation of the expense component analysis segment of the present invention. Financial planning systems generally use the same format used by basic financial systems in forecasting income statements, balance sheets and cash flow statements for future periods. Management uses the output from financial planning systems to highlight future financial difficulties with a lead time sufficient to permit effective corrective action and to identify problems in enterprise operations that may be reducing the profitability of the business below desired levels. These systems are most often developed by individuals within companies using two and three-dimensional spreadsheets such as Lotus 1-2-3 ®, Microsoft Excel ® and Quattro Pro ®. In some cases, financial planning systems are built within an executive information system (EIS) or decision support system (DSS). For the preferred embodiment of the present invention, the advanced finance system database is similar to the financial planning system database detailed in U.S. Pat. No. 5,165,109 for “Method of and System for Generating Feasible, Profit Maximizing Requisition Sets”, by Jeff S. Eder.

While advanced financial planning systems have been around for some time, asset management systems are a relatively recent development. Their appearance is further proof of the increasing importance of “soft” assets. Asset management systems include: customer relationship management systems, partner relationship management systems, channel management systems, knowledge management systems, visitor relationship management systems, intellectual property management systems, investor management systems, vendor management systems, alliance management systems, process management systems, brand management systems, workforce management systems, human resource management systems, email management systems, IT management systems and/or quality management systems. Asset management systems are similar to operation management systems in that they generally have the ability to forecast future events as well as track historical occurrences. As discussed previously, many of these systems have added analytical capabilities that allow them to identify trends and patterns in the data associated with the asset they are managing. Customer relationship management systems are the most well established asset management systems at this point and will be the focus of the discussion regarding asset management system data. In firms that sell customized products, the customer relationship management system is generally integrated with an estimating system that tracks the flow of estimates into quotations, orders and eventually bills of lading and invoices. In other firms that sell more standardized products, customer relationship management systems generally are used to track the sales process from lead generation to lead qualification to sales call to proposal to acceptance (or rejection) and delivery. All customer relationship management systems would be expected to track all of the customer's interactions with the enterprise after the first sale and store information similar to that shown below in Table 17.

TABLE 17
Customer Relationship Management System - Information

```
  1. Customer/Potential customer name
  2. Customer number
  3. Address
  4. Phone number
  5. Source of lead
  6. Date of first purchase
  7. Date of last purchase
  8. Last sales call/contact
  9. Sales call history
10. Sales contact history
11. Sales history: product/qty/price
12. Quotations: product/qty/price
13. Custom product percentage
14. Payment history
15. Current A/R balance
16. Average days to pay
```

Supply chain systems could be considered as asset management systems as they are used to manage a critical asset—supplier relationships. However, because of their importance and visibility they are listed separately. Supply chain management system databases (37) contain information that may have been in operation management system databases (10) in the past. These systems provide enhanced visibility into the availability of goods and promote improved coordination between customers and their suppliers. All supply chain management systems would be expected to track all of the items ordered by the enterprise after the first purchase and store information similar to that shown below in Table 18.

TABLE 18
Supply Chain Management System Information

```
  1. Stock Keeping Unit (SKU)
  2. Vendor
  3. Total Quantity on Order
  4. Total Quantity in Transit
  5. Total Quantity on Back Order
  6. Total Quantity in Inventory
  7. Quantity available today
  8. Quantity available next 7 days
  9. Quantity available next 30 days
10. Quantity available next 90 days
11. Quoted lead time
12. Actual average lead time
```

Project management systems, process management systems and risk management systems can also be integrated with the system of the present invention by mapping their data to the matrix of market value in a manner similar to that described for systems focused on the management of one element of value. These systems would in general have data that relates to more than one matrix cell.

System processing of the information from the different databases (5, 10, 12, 15, 17, 25, 30, 35, 37, 39) and the Internet (40) described above starts in a block 201, FIG. 4. The software in block 201 prompts the user (20) via the system settings data window (701) to provide system setting information. The system setting information entered by the user (20) is transmitted via the network (45) back to the application server (120) where it is stored in the system settings table (140) in the application database (50) in a manner that is well known. The specific inputs the user (20) is asked to provide at this point in processing are shown in Table 19.

```
TABLE 19
  1. New calculation or structure revision?
  2. Continuous, If yes, new calculation frequency? (by minute, hour, day,
  week)
  3. Organization structure (enterprises)
  4. Enterprise structures (segments of value, elements of value etc.)
  5. Enterprise industry classifications (SIC Code)
  6. Names of primary competitors by SIC Code
  7. Other keywords (brands, etc.)
  8. Baseline account structure
  9. Baseline element designations
10. Baseline factor designations
11. Baseline event risk designations
12. Baseline units of measure
13. Base currency
14. Geocoding standard
15. The maximum number of generations to be processed without
  improving fitness
16. Default clustering algorithm (selected from list) and maximum cluster
  number
17. Number of months a product is considered new after it is first
  produced
18. Default management report types (text, graphic, both)
19. Default missing data procedure
20. Maximum time to wait for user input
21. Maximum discount rate for new projects
22. Maximum number of sub elements
23. Confidence interval for risk reduction programs
24. Risk and return analysis time periods
25. Benchmark portfolio (optional)
26. Dates for history (optional)
27. Minimum working capital level (optional)
28. Detailed valuation using components of current operation value? (yes
  or no)
29. Use of industry real options? (yes or no)
30. Semantic mapping? (yes or no)
```

The system settings data is used by the software in block 202 to develop a market value matrix for each enterprise in the organization. The market value matrix is defined by the segments and elements of value for each enterprise. The subcategories for each element of value include the element base value, element variability risk, external factor variability risk, event risk. The application of the remaining system settings will be further explained as part of the detailed explanation of the system operation. The software in block 202 also uses the current system date to determine the time periods (generally in months) that require data to complete the calculations. In the preferred embodiment the analysis of enterprise value and risk by the system utilizes data from every data source for the four year period before and the three year forecast period after the specified valuation date and/or the date of system calculation. The user (20) also has the option of specifying the data periods that will be used for completing system calculations. After the date range is calculated it is stored in the system settings table (140), processing advances to a software block 210.

The software in block 210 communicates via a network (45) as required to locate and extract the information required for system processing from the different databases (5, 10, 12, 15, 17, 25, 30, 35, 37, 39) that are being integrated within the novel system for enterprise optimization. While any number of methods can be used to identify the different data sources, in the preferred embodiment the systems are identified using UDDI protocols and the systems include information that identifies the cell or cells within the market value matrix that their stored information pertains to as described previously. The data within each database that is available for extraction is tagged as described previously. The software in block 210 operates continuously to extract data. Processing in the system of the present invention continues on to a software block 303 that starts preparing the extracted data for analysis.

After the system processing described below has been completed, the tagged set of optimized features for each narrow system is sent by the a software block 610 back to a software block 240. The software in block 240 continually transmits the optimized feature set back to the narrow systems that have been integrated with the financial measurement and optimization system for implementation. The software in block 240 also stores requests for information from financial service provider systems such as those disclosed in cross-referenced application Ser. No. 10/012,374, filed Dec. 12, 2001 in the data request table (144) and transmits data transmissions to the financial service providers that have been approved by the user (20).

### Data Preparation

The flow diagrams in FIG. 5A, FIG. 5B and FIG. 5C, detail the processing that is completed by the portion of the application software (300) that prepares data for analysis.

The software in block 303 immediately passes processing to a software block 305. The software in block 305 checks the system settings table (140) and the matrix data table (143) to see if data are missing from any of the periods required for system calculation. The software in block 202 previously calculated and stored the range of required dates. If there are no data missing from any required period—other than derivative values which will be evaluated later—then processing advances to a software block 310. Alternatively, if there are missing data for any field except derivative values for any period, then processing advances to a block 306.

The software in block 306 prompts the user (20) via the missing data window (704) to specify the method to be used for filling the blanks for each field that is missing data. Options the user (20) can choose from for filling the blanks include: the average value for the item over the entire time period, the average value for the item over a specified period, zero, the average of the preceding item and the following item values and direct user input for each missing item. If the user (20) does not provide input within a specified interval, then the default missing data procedure specified in the system settings table (140) is used. When all the blanks have been filled and stored for all of the missing data, system processing advances to a block 310.

The software in block 310 prompts the user (20) via the frame definition window (705) to specify frames for analysis. Frames are sub-sets of each enterprise that can be analyzed at the value driver level separately. For example, the user (20) may wish to examine value and/or risk by country, by division, by project, by process, by action, by program or by manager. The software in block 310 saves the frame definitions the user (20) specifies in the frame definition table (146) by enterprise in the application database (50) before processing advances to a software block 311.

The software in block 311 assigns one or more frame designations to all element data and factor data that were stored in the matrix data table (143) in the prior stage (200) of processing. After storing the revised element and factor data records in the matrix data table (143), the software in the block retrieves the element, segment and external factor definitions from the system settings table (140) and updates and saves the revised definitions as required to reflect the impact of new frame definitions before processing advances to a software block 312.

The software in block 312 checks the matrix data table (143) to see if there are frame assignments for all element and factor data. If there are frame assignments for all data, then processing advances to a software block 321. Alternatively, if there are data without frame assignments, then processing advances to a software block 313.

The software in block 313 retrieves data from the matrix data table (143) that don't have frame assignments and then prompts the user (20) via the frame assignment window (707) to specify frame assignments for these variables. The software in block 313 saves the frame assignments the user (20) specifies as part of the data record for the variable in the matrix data table (143) by enterprise before processing advances to software block 321.

The software in block 321 checks the system settings table (140) to see if semantic mapping is being used. If semantic mapping is not being used, then processing advances to a block 324. Alternatively, if the software in block 321 determines that semantic mapping is being used, processing advances to a software block 322.

The software in block 322 checks the bot date table (149) and deactivates any inference bots with creation dates before the current system date and retrieves information from the system settings table (140) and the classified text table (151). The software in block 322 then initializes inference bots for each keyword (including competitor name) in the system settings table (140) and the classified text table (151) to activate with the frequency specified by user (20) in the system settings table (140).

Bots are independent components of the application that have specific tasks to perform. In the case of inference bots, their task is to use Bayesian inference algorithms to determine the characteristics that give meaning to the text associated with keywords and classified text previously stored in the application database (50). Every inference bot contains the information shown in Table 20.

TABLE 20
1. Unique ID number (based on date, hour, minute, second of creation)
2. Creation date (date, hour, minute, second)
3. Mapping information
4. Storage location
5. Organization
6. Enterprise
7. Keyword
8. Classified text mapping information

After being activated, the inference bots determine the characteristics that give the text meaning in accordance with their programmed instructions with the frequency specified by the user (20) in the system settings table (140). The information defining the characteristics that give the text meaning is stored in the semantic map table (145) and any new keywords identified during the processing are stored in the classified text table (151) in the application database (50) before processing advances to block 324.

The software in block 324 checks the bot date table (149) and deactivates any text bots with creation dates before the current system date and retrieves information from the system settings table (140), the classified text table (151) and the semantic map table (145). The software in block 324 then initializes text bots for each keyword stored in the two tables. The bots are programmed to activate with the frequency specified by user (20) in the system settings table (140).

Bots are independent components of the application that have specific tasks to perform. In the case of text bots, their tasks are to locate, count, classify and extract keyword matches from the external database (25) and the asset management system database (35) (note: this includes unstructured text) and then store the results as item variables in the specified location. The classification includes both the enterprise matrix cell (or cells) that the keyword is associated with and the context of the keyword mention in accordance with the semantic map that defines context. This dual classification allows the system of the present invention to identify both the number of times a keyword was mentioned and the context in which the keyword appeared. Every bot initialized by software block 324 will store the extracted location, count, date and classification data it discovers in the classified text table (151) by matrix cell, by enterprise. Every text bot contains the information shown in Table 21.

```
TABLE 21
  1. Unique ID number (based on date, hour, minute, second of creation)
  2. Creation date (date, hour, minute, second)
  3. Storage location
  4. Mapping information
  5. Organization
  6. Enterprise
  7. Data source
  8. Keyword
  9. Storage location
10. Semantic map
```

After being initialized, the bots locate data from the external database (25) or the asset management system database (35) in accordance with its programmed instructions with the frequency specified by user (20) in the system settings table (140). As each bot locates and extracts text data, processing advances to a software block 325 before the bot completes data storage. The software in block 325 checks to see if all keyword hits are classified by enterprise, matrix cell and semantic map. If the software in block 325 does not find any unclassified “chits”, then the address, count and classified text are stored in the classified text table (151) by enterprise. Alternatively, if there are terms that have not been classified, then processing advances to a block 330. The software in block 330 prompts the user (20) via the identification and classification rules window (703) to provide classification rules for each new term. The information regarding the new classification rules is stored in the semantic map table (145) while the newly classified text is stored in the classified text table (151) by enterprise. It is worth noting at this point that the activation and operation of bots with classified data (50) continues. Only bots with unclassified fields “wait” for user input before completing data storage. The new classification rules will be used the next time bots are initialized in accordance with the frequency established by the user (20). In either event, system processing then passes on to software block 326.

The software in block 326 checks the bot date table (149) and deactivates any internet text and linkage bots with creation dates before the current system date and retrieves information from the system settings table (140), the classified text table (151) and the semantic map table (145). The software in block 324 then initializes text bots for each keyword stored in the two tables. The bots are programmed to activate with the frequency specified by user (20) in the system settings table (140).

Bots are independent components of the application that have specific tasks to perform. In the case of internet text and linkage bots, their tasks are to locate, count, classify and extract keyword matches and linkages from the Internet (40) and then store the results as item variables in a specified location. The classification includes the enterprise matrix cell (or cells) that the keyword is associated with, the context of the keyword mention in accordance with the semantic map that defines context and the links associated with the keyword. Every bot initialized by software block 326 will store the extracted location, count, date, classification and linkage data it discovers in the classified text table (151) by matrix cell, by enterprise. Multimedia data can be processed using these same bots if software to translate and parse the multimedia content is included in each bot. Every Internet text and linkage bot contains the information shown in Table 22.

TABLE 22
1. Unique ID number (based on date, hour, minute, second of creation)
2. Creation date (date, hour, minute, second)
3. Storage location
4. Mapping information
5. Home URL
6. Organization
7. Enterprise
8. Keyword
9. Semantic map

After being initialized, the text and linkage bots locate and classify data from the Internet (40) in accordance with their programmed instructions with the frequency specified by user (20) in the system settings table (140). As each bot locates and classifies data from the Internet (40) processing advances to a software block 325 before the bot completes data storage. The software in block 325 checks to see if all linkages and keyword hits have been classified by enterprise, matrix cell and semantic map. If the software in block 325 does not find any unclassified “hits” or “links”, then the address, counts, dates, linkages and classified text are stored in the classified text table (151) by enterprise. Alternatively, if there are hits or links that haven't been classified, then processing advances to a block 330. The software in block 330 prompts the user (20) via the identification and classification rules window (703) to provide classification rules for each new hit or link. The information regarding the new classification rules is stored in the semantic map table (145) while the newly classified text and linkages are stored in the classified text table (151) by enterprise. It is worth noting at this point that the activation and operation of bots where all fields map to the application database (50) continues. Only bots with unclassified fields will “wait” for user input before completing data storage. The new classification rules will be used the next time bots are initialized in accordance with the frequency established by the user (20). In either event, system processing then passes on to a software block 351.

The software in block 351 checks the matrix data table (143) in the application database (50) to see if there are historical values for all the derivatives stored in the table. Because SFAS 133 is still not fully implemented, some companies may not have data regarding the value of their derivatives during a time period where data are required. If there are values stored for all required time periods, then processing advances to a software block 355. Alternatively, if there are periods when the value of one or more derivatives has not been stored, then processing advances to a software block 352. The software in block 352 retrieves the required data from the matrix data table (143) as required to value each derivative using a risk neutral valuation method for the time period or time periods that are missing values. The algorithms used for this analysis can include Quasi Monte Carlo or equivalent Martingale. Other algorithms can be used to the same effect. When the calculations are completed, the resulting values are stored in the matrix data table (143) by enterprise and processing advances to software block 355.

The software in block 355 calculates pre-defined attributes by item for each numeric item variable in the matrix data table (143) and the classified text table (151). The attributes calculated in this step include: summary data like cumulative total value; ratios like the period to period rate of change in value; trends like the rolling average value, comparisons to a baseline value like change from a prior years level and time lagged values like the time lagged value of each numeric item variable. The software in block 355 calculates similar attributes for the text and geospatial item variables stored in the matrix data table (143). The software in block 355 also calculates attributes for each item date variable in the matrix data table (143) and the classified text table (151) including summary data like time since last occurrence and cumulative time since first occurrence; and trends like average frequency of occurrence and the rolling average frequency of occurrence. The numbers derived from the item variables are collectively referred to as “item performance indicators”. The software in block 355 also calculates pre-specified combinations of variables called composite variables for measuring the strength of the different elements of value. The item performance indicators and the composite variables are tagged and stored in the matrix data table (143) or the classified text table (151) by enterprise before processing advances to a block 356.

The software in block 356 uses attribute derivation algorithms such as the AQ program to create combinations of the variables that were not pre-specified for combination. While the AQ program is used in the preferred embodiment of the present invention, other attribute derivation algorithms, such as the LINUS algorithms, may be used to the same effect. The software creates these attributes using both item variables that were specified as “element” variables and item variables that were not. The resulting composite variables are tagged and stored in the matrix data table (143) before processing advances to a block 357.

The software in block 357 derives external factor indicators for each factor numeric data field stored in the matrix data table (143). For example, external factors include: the ratio of enterprise earnings to expected earnings, the number and amount of jury awards, commodity prices, the inflation rate, growth in gross domestic product, enterprise earnings volatility vs. industry average volatility, short and long term interest rates, increases in interest rates, insider trading direction and levels, industry concentration, consumer confidence and the unemployment rate that have an impact on the market price of the equity for an enterprise and/or an industry. The external factor indicators derived in this step include: summary data like cumulative totals, ratios like the period to period rate of change, trends like the rolling average value, comparisons to a baseline value like change from a prior years price and time lagged data like time lagged earnings forecasts. In a similar fashion the software in block 357 calculates external factors for each factor date field in the matrix data table (143) including summary factors like time since last occurrence and cumulative time since first occurrence; and trends like average frequency of occurrence and the rolling average frequency of occurrence. The numbers derived from numeric and date fields are collectively referred to as “factor performance indicators”. The software in block 357 also calculates pre-specified combinations of variables called composite factors for measuring the strength of the different external factors. The external factors, factor performance indicators and the composite factors are tagged and stored in the matrix data table (143) by matrix cell before processing advances to a block 360.

The software in block 360 uses attribute derivation algorithms, such as the Linus algorithm, to create combinations of the external factors that were not pre-specified for combination. While the Linus algorithm is used in the preferred embodiment of the present invention, other attribute derivation algorithms, such as the AQ program, may be used to the same effect. The software creates these attributes using both external factors that were included in “composite factors” and external factors that were not. The resulting composite variables are tagged and stored in the matrix data table (143) by matrix cell before processing advances to a block 361.

The software in block 361 uses pattern-matching algorithms to classify data fields for elements of value and external factors to pre-defined groups with numerical values. This type of analysis is useful in classifying transaction patterns as “heavy”, “light”, “moderate” or “sporadic”. This analysis can be used to classify web site activity, purchasing patterns and advertising frequency among other things. The numeric values associated with the classifications are item performance indicators. They are tagged and stored in the matrix data table (143) by matrix cell before processing advances to a block 362.

The software in block 362 retrieves data from the system settings table (140) and the matrix data table (143) as required to calculate the historical risk and return for the benchmark portfolio identified by the user (20) in the system settings table. After the calculation is completed, the resulting value is saved in the benchmark return table (147) in the application database (50). When data storage is complete, processing advances to a software block 305.

### Analysis

The flow diagrams in FIG. 6A, FIG. 6B and FIG. 6C detail the processing that is completed by the portion of the application software (400) that continually generates a matrix quantifying the impact of elements of value, segments of value and event risks on the segments of value for each enterprise within the organization (see FIG. 11) by creating and activating analysis bots that:

1) Identify the factor variables, factor performance indicators and composite variables for each external factor that drive: three of the segments of value—current operation, derivatives and excess financial assets—as well as the components of current operation value (revenue, expense and changes in capital);

2) Identify the item variables, item performance indicators and composite variables for each element and sub-element of value that drive: three segments of value—current operation, derivatives and financial assets—as well as the components of current operation value (revenue, expense and changes in capital);

3) Create vectors that summarize the impact of the factor variables, factor performance indicators and composite variables for each external factor;

4) Create vectors that summarize the performance of the item variables, item performance indicators and composite variables for each element of value and sub-element of value in driving segment value;

5) Determine the expected life of each element of value and sub-element of value;

6) Determine the current operation value, excess financial asset value and derivative value, revenue component value, expense component value and capital component value of said current operations using the information prepared in the previous stages of processing;

7) Specify and optimize causal predictive models to determine the relationship between the vectors generated in steps 3 and 4 and the three segments of value, current operation, derivatives and financial assets, as well as the components of current operation value (revenue, expense and changes in capital);

8) Determine the appropriate discount rate on the basis of relative causal element strength, value the enterprise real options and contingent liabilities and determine the contribution of each element to real option valuation;

9) Determine the best causal indicator for enterprise stock price movement, calculate market sentiment and analyze the causes of market sentiment;

10) Combine the results of all prior stages of processing to determine the value of each element, sub-element, event risk and factor for each enterprise and the organization; and

11) Identify the split between base value and variability within each element and factor value.

Each analysis bot generally normalizes the data being analyzed before processing begins. While the processing in the preferred embodiment includes an analysis of all five segments of value for the organization, it is to be understood that the system of the present invention can complete calculations for any combination of the five segments. For example, when a company is privately held it does not have a market price and as a result the market sentiment segment of value is not analyzed.

Processing in this portion of the application begins in software block 402. The software in block 402 checks the system settings table (140) in the application database (50) to determine if the current calculation is a new calculation or a structure change. If the calculation is not a new calculation or a structure change, then processing advances to a software block 415. Alternatively, if the calculation is new or a structure change, then processing advances to a software block 403.

The software in block 403 retrieves data from the system settings table (140) and the matrix data table (143) and then assigns item variables, item performance indicators and composite variables to each element of value identified in the system settings table (140) using a three-step process. First, item variables, item performance indicators and composite variables are assigned to elements of value based on the asset management system they correspond to (for example, all item variables from a brand management system and all item performance indicators and composite variables derived from brand management system item variables are assigned to the brand element of value). Second, pre-defined composite variables are assigned to the element of value they were assigned to measure in the system settings table (140). Finally, item variables, item performance indicators and composite variables identified by the text and geospatial bots are assigned to elements on the basis of their element classifications. If any item variables, item performance indicators or composite variables are un-assigned at this point they are assigned to a going concern element of value. After the assignment of variables and indicators to elements is complete, the resulting assignments are saved to the matrix data table (143) by enterprise and processing advances to a block 404.

The software in block 404 retrieves data from the system settings table (140), the matrix data table (143) and the frame definition table (146) and then assigns factor variables, factor performance indicators and composite factors to each external factor. Factor variables, factor performance indicators and composite factors identified by the text bots are then assigned to factors on the basis of their factor classifications. The resulting assignments are saved to the matrix data table (143) by enterprise and processing advances to a block 405.

The software in block 405 checks the system settings table (140) in the application database (50) to determine if any of the enterprises in the organization being analyzed have market sentiment segments. If there are market sentiment segments for any enterprise, then processing advances to a block 406. Alternatively, if there are no market prices for equity for any enterprise, then processing advances to a software block 408.

The software in block 406 checks the bot date table (149) and deactivates any market value indicator bots with creation dates before the current system date. The software in block 406 then initializes market value indicator bots in accordance with the frequency specified by the user (20) in the system settings table (140). The bot retrieves the information from the system settings table (140) and the matrix data table (143) before saving the resulting information in the application database (50).

Bots are independent components of the application that have specific tasks to perform. In the case of market value indicator bots their primary task is to identify the best market value indicator (price, relative price, yield, option price, first derivative of price change or second derivative of price change) for the time period being examined. The market value indicator bots select the best value indicator by grouping the S&P 500 using each of the five value indicators with a Kohonen neural network. The resulting clusters are then compared to the known groupings of the S&P 500. The market value indicator that produced the clusters that most closely match the know S&P 500 is selected as the market value indicator. Every market value indicator bot contains the information shown in Table 23.

TABLE 23
1. Unique ID number (based on date, hour, minute, second of creation)
2. Creation date (date, hour, minute, second)
3. Mapping information
4. Storage location
5. Organization
6. Enterprise

### When bot in block 406 have identified and stored the best market value indicator in the matrix data table (143), processing advances to a block 407.

The software in block 407 checks the bot date table (149) and deactivates any temporal clustering bots with creation dates before the current system date. The software in block 407 then initializes a bot in accordance with the frequency specified by the user (20) in the system settings table (140). The bot retrieves information from the system settings table (140) and the matrix data table (143) as required and define regimes for the enterprise market value before saving the resulting cluster information in the application database (50).

Bots are independent components of the application that have specific tasks to perform. In the case of temporal clustering bots, their primary task is to segment the market price data by enterprise using the market value indicator selected by the bot in block 406 into distinct time regimes that share similar characteristics. The temporal clustering bot assigns a unique identification (id) number to each “regime” it identifies before tagging and storing the unique id numbers in the matrix data table (143). Every time period with data are assigned to one of the regimes. The cluster id for each regime is saved in the data record for each piece of element data and factor data in the matrix data table (143) by enterprise. If there are enterprises in the organization that don't have market sentiment calculations, then the time regimes from the primary enterprise specified by the user in the system settings table (140) are used in labeling the data for the other enterprises. The time periods are segmented for each enterprise with a market value using a competitive regression algorithm that identifies an overall, global model before splitting the data and creating new models for the data in each partition. If the error from the two models is greater than the error from the global model, then there is only one regime in the data. Alternatively, if the two models produce lower error than the global model, then a third model is created. If the error from three models is lower than from two models then a fourth model is added. The process continues until adding a new model does not improve accuracy. Other temporal clustering algorithms may be used to the same effect. Every temporal clustering bot contains the information shown in Table 24.

TABLE 24
1. Unique ID number (based on date, hour, minute, second of creation)
2. Creation date (date, hour, minute, second)
3. Mapping information
4. Storage location
5. Maximum number of clusters
6. Organization
7. Enterprise

### When bots in block 407 have identified and stored regime assignments for all time periods with data by enterprise, processing advances to a software block 408.

The software in block 408 checks the bot date table (149) and deactivates any variable clustering bots with creation dates before the current system date. The software in block 408 then initializes bots as required for each element of value and external factor by enterprise. The bots: activate in accordance with the frequency specified by the user (20) in the system settings table (140), retrieve the information from the system settings table (140) and the matrix data table (143) as required and define segments for the element data and factor data before tagging and saving the resulting cluster information in the matrix data table (143).

Bots are independent components of the application that have specific tasks to perform. In the case of variable clustering bots, their primary task is to segment the element data and factor data into distinct clusters that share similar characteristics. The clustering bot assigns a unique id number to each “cluster” it identifies, tags and stores the unique id numbers in the matrix data table (143). Every item variable for every element of value is assigned to one of the unique clusters. The cluster id for each variable is saved in the data record for each variable in the table where it resides. In a similar fashion, every factor variable for every external factor is assigned to a unique cluster. The cluster id for each variable is tagged and saved in the data record for the factor variable. The element data and factor data are segmented into a number of clusters less than or equal to the maximum specified by the user (20) in the system settings table (140). The data are segmented using the “default” clustering algorithm the user (20) specified in the system settings table (140). The system of the present invention provides the user (20) with the choice of several clustering algorithms including: an unsupervised “Kohonen” neural network, neural network, decision tree, support vector method, K-nearest neighbor, expectation maximization (EM) and the segmental K-means algorithm. For algorithms that normally require the number of clusters to be specified, the bot will iterate the number of clusters until it finds the cleanest segmentation for the data. Every variable clustering bot contains the information shown in Table 25.

```
TABLE 25
  1. Unique ID number (based on date, hour, minute, second of creation)
  2. Creation date (date, hour, minute, second)
  3. Mapping information
  4. Storage location
  5. Element of value, sub element of value or external factor
  6. Clustering algorithm type
  7. Organization
  8. Enterprise
  9. Maximum number of clusters
10. Variable 1
. . . to
10 + n. Variable n
```

### When bots in block 408 have identified, tagged and stored cluster assignments for the data associated with each element of value, sub-element of value or external factor in the matrix data table (143), processing advances to a software block 409.

The software in block 409 checks the bot date table (149) and deactivates any predictive model bots with creation dates before the current system date. The software in block 409 then retrieves the information from the system settings table (140), the system settings table (140) and the matrix data table (143) as required to initialize predictive model bots for each component of value.

Bots are independent components of the application that have specific tasks to perform. In the case of predictive model bots, their primary task is to determine the relationship between the element and factor data and the derivative segment of value, the excess financial asset segment of value and the current operation segment of value by enterprise. The predictive model bots also determine the relationship between the element data and factor data and the components of current operation value and sub-components of current operation value by enterprise. Predictive model bots are initialized for each component of value, sub-component of value, derivative segment and excess financial asset segment by enterprise. They are also initialized for each cluster and regime of data in accordance with the cluster and regime assignments specified by the bots in blocks 407 and 408 by enterprise. A series of predictive model bots is initialized at this stage because it is impossible to know in advance which predictive model type will produce the “best” predictive model for the data from each commercial enterprise. The series for each model includes 12 predictive model bot types: neural network; CART; GARCH, projection pursuit regression; generalized additive model (GAM), redundant regression network; rough-set analysis, boosted Naive Bayes Regression; MARS; linear regression; support vector method and stepwise regression. Additional predictive model types can be used to the same effect. The software in block 409 generates this series of predictive model bots for the enterprise as shown in Table 26.

TABLE 26
Predictive models by enterprise level

Enterprise:
Variables* relationship to enterprise cash flow (revenue − expense +
capital change)
Variables* relationship to enterprise revenue component of value
Variables* relationship to enterprise expense subcomponents of value
Variables* relationship to enterprise capital change subcomponents of
value
Variables* relationship to derivative segment of value
Variables* relationship to excess financial asset segment of value
Element of Value:
Sub-element of value variables relationship to element of value
*Variables = element and factor data.

Every predictive model bot contains the information shown in Table 27.

```
TABLE 27
  1. Unique ID number (based on date, hour, minute, second of creation)
  2. Creation date (date, hour, minute, second)
  3. Mapping information
  4. Storage location
  5. Organization
  6. Enterprise
  7. Global or Cluster (ID) and/or Regime (ID)
  8. Segment (Derivative, Excess Financial Asset or Current Operation)
  9. Element, sub-element or external factor
10. Predictive Model Type
```

After predictive model bots are initialized, the bots activate in accordance with the frequency specified by the user (20) in the system settings table (140). Once activated, the bots retrieve the required data from the appropriate table in the application database (50) and randomly partition the element or factor data into a training set and a test set. The software in block 409 uses “bootstrapping” where the different training data sets are created by re-sampling with replacement from the original training set so data records may occur more than once. After the predictive model bots complete their training and testing, processing advances to a block 410.

The software in block 410 determines if clustering improved the accuracy of the predictive models generated by the bots in software block 409 by enterprise. The software in block 410 uses a variable selection algorithm such as stepwise regression (other types of variable selection algorithms can be used) to combine the results from the predictive model bot analyses for each type of analysis—with and without clustering—to determine the best set of variables for each type of analysis. The type of analysis having the smallest amount of error as measured by applying the mean squared error algorithm to the test data is given preference in determining the best set of variables for use in later analysis. There are four possible outcomes from this analysis as shown in Table 28.

TABLE 28

1. Best model has no clustering
2. Best model has temporal clustering, no variable clustering
3. Best model has variable clustering, no temporal clustering
4. Best model has temporal clustering and variable clustering

If the software in block 410 determines that clustering improves the accuracy of the predictive models for an enterprise, then processing advances to a software block 413. Alternatively, if clustering does not improve the overall accuracy of the predictive models for an enterprise, then processing advances to a software block 411.

The software in block 411 uses a variable selection algorithm such as stepwise regression (other types of variable selection algorithms can be used) to combine the results from the predictive model bot analyses for each model to determine the best set of variables for each model. The models having the smallest amount of error as measured by applying the mean squared error algorithm to the test data is given preference in determining the best set of variables. As a result of this processing, the best set of variables contain: the item variables, factor variables, item performance indicators, factor performance indications, composite variables and composite factors (aka element data and factor data) that correlate most strongly with changes in the three segments being analyzed and the three components of value. The best set of variables will hereinafter be referred to as the “value drivers”. Eliminating low correlation factors from the initial configuration of the vector creation algorithms increases the efficiency of the next stage of system processing. Other error algorithms alone or in combination may be substituted for the mean squared error algorithm. After the best set of variables have been selected, tagged and stored in the matrix data table (143) for all models at all levels for each enterprise in the organization, the software in block 411 tests the independence of the value drivers at the enterprise, external factor, element and sub-element level before processing advances to a block 412.

The software in block 412 checks the bot date table (149) and deactivates any causal predictive model bots with creation dates before the current system date. The software in block 412 then retrieves the information from the system settings table (140) and the matrix data table (143) as required to initialize causal predictive model bots for each element of value, sub-element of value and external factor in accordance with the frequency specified by the user (20) in the system settings table (140).

Bots are independent components of the application that have specific tasks to perform. In the case of causal predictive model bots, their primary task is to refine the value driver selection to reflect only causal variables. (Note: these variables are summed together to value an element when they are interdependent). A series of causal predictive model bots are initialized at this stage because it is impossible to know in advance which causal predictive model will produce the “best” vector for the best fit variables from each model. The series for each model includes five causal predictive model bot types: Tetrad, MML, LaGrange, Bayesian and path analysis. The software in block 412 generates this series of causal predictive model bots for each set of value drivers stored in the matrix data table (143) in the previous stage in processing. Every causal predictive model bot activated in this block contains the information shown in Table 29.

```
TABLE 29
  1. Unique ID number (based on date, hour, minute, second of creation)
  2. Creation date (date, hour, minute, second)
  3. Mapping information
  4. Storage location
  5. Component or subcomponent of value
  6. Element, sub-element or external factor
  7. Variable set
  8. Causal predictive model type
  9. Organization
10. Enterprise
```

After the causal predictive model bots are initialized by the software in block 412, the bots activate in accordance with the frequency specified by the user (20) in the system settings table (140). Once activated, they retrieve the required information for each model and sub-divide the variables into two sets, one for training and one for testing. After the causal predictive model bots complete their processing for each model, the software in block 412 uses a model selection algorithm to identify the model that best fits the data for each element of value, sub-element of value and external factor being analyzed. For the system of the present invention, a cross validation algorithm is used for model selection. The software in block 412 tags and saves the best fit causal factors in the vector table (153) by enterprise in the application database (50) and processing advances to a block 418.

The software in block 418 tests the value drivers to see if there is interaction between elements, between elements and external factors or between external factors by enterprise. The software in this block identifies interaction by evaluating a chosen model based on stochastic-driven pairs of value-driver subsets. If the accuracy of such a model is higher that the accuracy of statistically combined models trained on attribute subsets, then the attributes from subsets are considered to be interacting and then they form an interacting set. If the software in block 418 does not detect any value driver interaction or missing variables for each enterprise, then system processing advances to a block 423. Alternatively, if missing data or value driver interactions across elements are detected by the software in block 418 for one or more enterprise, then processing advances to a software block 421.

If software in block 410 determines that clustering improves predictive model accuracy, then processing advances to block 413 as described previously. The software in block 413 uses a variable selection algorithm such as stepwise regression (other types of variable selection algorithms can be used) to combine the results from the predictive model bot analyses for each model, cluster and/or regime to determine the best set of variables for each model. The models having the smallest amount of error as measured by applying the mean squared error algorithm to the test data is given preference in determining the best set of variables. As a result of this processing, the best set of variables contains: the element data and factor data that correlate most strongly with changes in the components of value. The best set of variables will hereinafter be referred to as the “value drivers”. Eliminating low correlation factors from the initial configuration of the vector creation algorithms increases the efficiency of the next stage of system processing. Other error algorithms alone or in combination may be substituted for the mean squared error algorithm. After the best set of variables have been selected, tagged as value drivers and stored in the matrix data table (143) for all models at all levels by enterprise, the software in block 413 tests the independence of the value drivers at the enterprise, element, sub-element and external factor level before processing advances to a block 414.

The software in block 414 checks the bot date table (149) and deactivates any causal predictive model bots with creation dates before the current system date. The software in block 414 then retrieves the information from the system settings table (140) and the matrix data table (143) as required to initialize causal predictive model bots for each element of value, sub-element of value and external factor at every level in accordance with the frequency specified by the user (20) in the system settings table (140).

Bots are independent components of the application that have specific tasks to perform. In the case of causal predictive model bots, their primary task is to refine the element and factor value driver selection to reflect only causal variables. (Note: these variables are grouped together to represent a single element vector when they are dependent). In some cases it may be possible to skip the correlation step before selecting causal the item variables, factor variables, item performance indicators, factor performance indicators, composite variables and composite factors (aka element data and factor data). A series of causal predictive model bots are initialized at this stage because it is impossible to know in advance which causal predictive model will produce the “best” vector for the best fit variables from each model. The series for each model includes four causal predictive model bot types: Tetrad, LaGrange, Bayesian and path analysis. The software in block 414 generates this series of causal predictive model bots for each set of value drivers stored in the matrix data table (143) in the previous stage in processing. Every causal predictive model bot activated in this block contains the information shown in Table 30.

```
TABLE 30
  1. Unique ID number (based on date, hour, minute, second of creation)
  2. Creation date (date, hour, minute, second)
  3. Mapping information
  4. Storage location
  5. Component or subcomponent of value
  6. Cluster (ID) and/or Regime (ID)
  7. Element, sub-element or external factor
  8. Variable set
  9. Organization
10. Enterprise
11. Causal predictive model type
```

After the causal predictive model bots are initialized by the software in block 414, the bots activate in accordance with the frequency specified by the user (20) in the system settings table (140). Once activated, they retrieve the required information for each model and sub-divide the variables into two sets, one for training and one for testing. The same set of training data is used by each of the different types of bots for each model.

After the causal predictive model bots complete their processing for each model, the software in block 414 uses a model selection algorithm to identify the model that best fits the data for each element, sub-element or external factor being analyzed by model and/or regime by enterprise. For the system of the present invention, a cross validation algorithm is used for model selection. The software in block 414 tags and saves the best fit causal factors in the vector table (153) by enterprise in the application database (50) and processing advances to block 418. The software in block 418 tests the value drivers to see if there are “missing” value drivers that are influencing the results as well as testing to see if there are interactions (dependencies) across elements and/or external factors. If the software in block 418 does not detect any missing data or value driver interactions across elements or factors, then system processing advances to a block 423. Alternatively, if missing data or value driver interactions across elements or factors are detected by the software in block 418, then processing advances to a software block 421.

The software in block 421 prompts the user (20) via the structure revision window (710) to adjust the specification(s) for the affected elements of value, sub-elements of value or external factors as required to minimize or eliminate the interaction. At this point the user (20) has the option of specifying that one or more elements of value, sub elements of value and/or external factors be combined for analysis purposes (element combinations and/or factor combinations) for each enterprise where there is interaction between elements and/or factors. The user (20) also has the option of specifying that the elements or external factors that are interacting will be valued by summing the impact of their value drivers. Finally, the user (20) can choose to re-assign a value driver to a new element of value or external factor to eliminate the inter-dependency. This is the preferred solution when the inter-dependent value driver is included in the going concern element of value. Elements and external factors that will be valued by summing their value drivers will not have vectors generated.

Elements of value and external factors do not share value drivers and they are not combined with one another. However, when an external factor and an element of value are shown to be inter-dependent, it is usually because the element of value is a dependent on the external factor. For example, the value of a process typically varies with the price of commodities consumed in the process. In that case, the value of both the external factor and the element of value would be expected to be a function of the same value driver. The software in block 421 will examine all the factor-element combinations and suggest the appropriate percentage of factor risk assignment to the different elements it interacts with. For example, 30% of a commodity factor risk could be distributed to each of the 3 processes that consume the commodity with the remaining 10% staying in the going concern element of value. The user (20) either accepts the suggested distribution or specifies his own distribution for each factor-element interaction.

After the input from the user (20) is saved in the system settings table (140) and the matrix data table (143) system processing advances to a software block 423. The software in block 423 checks the system settings table (140) and the matrix data table (143) to see if there any changes in structure. If there have been changes in the structure, then processing advances to block 303 and the system processing described previously is repeated. Alternatively, if there are no changes in structure, then processing advances to a block 425.

The software in block 425 checks the system settings table (140) in the application database (50) to determine if the current calculation is a new one. If the calculation is new, then processing advances to a software block 426. Alternatively, if the calculation is not a new calculation, then processing advances to a software block 433.

The software in block 426 checks the bot date table (149) and deactivates any industry rank bots with creation dates before the current system date. The software in block 426 then retrieves the information from the system settings table (140) and the industry ranking table (154) as required to initialize industry rank bots for the enterprise and for the industry in accordance with the frequency specified by the user (20) in the system settings table (140).

Bots are independent components of the application that have specific tasks to perform. In the case of industry rank bots, their primary task is to determine the relative position of each enterprise being evaluated on element data identified in the previous processing step. (Note: these variables are grouped together when they are interdependent). The industry rank bots use ranking algorithms such as Data Envelopment Analysis (hereinafter, DEA) to determine the relative industry ranking of the enterprise being examined. The software in block 426 generates industry rank bots for each enterprise being evaluated. Every industry rank bot activated in this block contains the information shown in Table 31.

TABLE 31
1. Unique ID number (based on date, hour, minute, second of creation)
2. Creation date (date, hour, minute, second)
3. Mapping information
4. Storage location
5. Ranking algorithm
6. Organization
7. Enterprise

After the industry rank bots are initialized by the software in block 426, the bots activate in accordance with the frequency specified by the user (20) in the system settings table (140). Once activated, they retrieve the item variables, item performance indicators, and composite variables from the application database (50) and sub-divides them into two sets, one for training and one for testing. After the industry rank bots develop and test their rankings, the software in block 426 saves the industry rankings in the industry ranking table (154) by enterprise in the application database (50) and processing advances to a block 427. The industry rankings are item variables.

The software in block 427 checks the bot date table (149) and deactivates any vector generation bots with creation dates before the current system date. The software in block 427 then initializes bots for each element of value, sub-element of value and external factor for each enterprise in the organization. The bots activate in accordance with the frequency specified by the user (20) in the system settings table (140), retrieve the information from the system settings table (140) and the matrix data table (143) as required to initialize vector generation bots for each element of value and sub-element of value in accordance with the frequency specified by the user (20) in the system settings table (140).

Bots are independent components of the application that have specific tasks to perform. In the case of vector generation bots, their primary task is to produce formulas, (hereinafter, vectors) that summarize the relationship between the causal value drivers and changes in the component or sub-component of value being examined for each enterprise. The causal value drivers may be grouped by element of value, sub-element of value, external factor, factor combination or element combination. As discussed previously, the vector generation step is skipped for value drivers where the user has specified that value driver impacts will be mathematically summed to determine the value of the element or factor. The vector generation bots use induction algorithms to generate the vectors. Other vector generation algorithms can be used to the same effect. The software in block 427 generates a vector generation bot for each set of causal value drivers stored in the matrix data table (143). Every vector generation bot contains the information shown in Table 32.

TABLE 32
1. Unique ID number (based on date, hour, minute, second of creation)
2. Creation date (date, hour, minute, second)
3. Mapping information
4. Storage location
5. Organization
6. Enterprise
7. Element, sub-element, element combination, factor or factor
combination
8. Component or sub-component of value
9. Factor 1
. . . to
9 + n. Factor n

When bots in block 427 have identified, tagged and stored vectors for all time periods with data for all the elements, sub-elements, element combination, factor combination or external factor where vectors are being calculated in the matrix data table (143) and the vector table (153) by enterprise, processing advances to a software block 429.

The software in block 429 checks the bot date table (149) and deactivates any financial factor bots with creation dates before the current system date. The software in block 429 then retrieves the information from the system settings table (140) and the matrix data table (143) as required to initialize causal external factor bots for the enterprise and the relevant industry in accordance with the frequency specified by the user (20) in the system settings table (140).

Bots are independent components of the application that have specific tasks to perform. In the case of financial factor bots, their primary task is to identify elements of value, value drivers and external factors that are causal factors for changes in the value of: derivatives, financial assets, enterprise equity and industry equity. The causal factors for enterprise equity and industry equity are those that drive changes in the value indicator identified by the value indicator bots. A series of financial factor bots are initialized at this stage because it is impossible to know in advance which causal factors will produce the “best” model for every derivative, financial asset, enterprise or industry. The series for each model includes five causal predictive model bot types: Tetrad, LaGrange, MML, Bayesian and path analysis. Other causal predictive models can be used to the same effect. The software in block 429 generates this series of causal predictive model bots for each set of causal value drivers stored in the matrix data table (143) in the previous stage in processing by enterprise. Every financial factor bot activated in this block contains the information shown in Table 33.

```
TABLE 33
  1. Unique ID number (based on date, hour, minute, second of creation)
  2. Creation date (date, hour, minute, second)
  3. Mapping information
  4. Storage location
  5. Element, value driver or external factor
  6. Organization
  7. Enterprise
  8. Type: derivatives, financial assets, enterprise equity or industry equity
  9. Value indicator (price, relative price, first derivative, etc.) for
  enterprise and industry only
10. Causal predictive model type
```

After the software in block 429 initializes the financial factor bots, the bots activate in accordance with the frequency specified by the user (20) in the system settings table (140). Once activated, they retrieve the required information and sub-divide the data into two sets, one for training and one for testing. The same set of training data is used by each of the different types of bots for each model. After the financial factor bots complete their processing for each segment of value, enterprise and industry, the software in block 429 uses a model selection algorithm to identify the model that best fits the data for each. For the system of the present invention, a cross validation algorithm is used for model selection. The software in block 429 tags and saves the best fit causal value drivers in the matrix data table (143) by enterprise and processing advances to a block 430. The software in block 430 tests to see if there are “missing” causal factors, elements or value drivers that are influencing the results by enterprise. If the software in block 430 does not detect any missing factors, elements or value drivers, then system processing advances to a block 431. Alternatively, if missing factors, elements or value drivers are detected by the software in block 430, then processing returns to software block 421 and the processing described in the preceding section is repeated.

The software in block 431 checks the bot date table (149) and deactivates any option bots with creation dates before the current system date. The software in block 431 then retrieves the information from the system settings table (140), the matrix data table (143), the vector table (153) and the industry ranking table (154) as required to initialize option bots for the enterprise.

Bots are independent components of the application that have specific tasks to perform. In the case of option bots, their primary tasks are to calculate the discount rate to be used for valuing the real options and contingent liabilities and to value the real options and contingent liabilities for the enterprise. If the user (20) has chosen to include industry options, then option bots will be initialized for industry options as well. The discount rate for enterprise real options is calculated by adding risk factors for each causal element to a base discount rate. A two step process determines the risk factor for each causal element. The first step in the process divides the maximum real option discount rate (specified by the user in system settings) by the number of causal elements. The second step in the process determines if the enterprise is highly rated on the causal elements using ranking algorithms like DEA and determines an appropriate risk factor. If the enterprise is highly ranked on the soft asset, then the discount rate is increased by a relatively small amount for that causal element. Alternatively, if the enterprise has a low ranking on a causal element, then the discount rate is increased by a relatively large amount for that causal element as shown below in Table 34.

TABLE 34
Maximum discount rate = 50%, Causal elements = 5
Maximum risk factor/soft asset = 50%/5 = 10%

| Industry Rank on Soft Asset | % of Maximum |
|---|---|
| 1 | 0% |
| 2 | 25% |
| 3 | 50% |
| 4 | 75% |
| 5 or higher | 100% |

| Causal element: | Relative Rank | Risk Factor |
|---|---|---|
| Brand | 1 | 0% |
| Channel | 3 | 5% |
| Manufacturing Process | 4 | 7.5% |
| Strategic Alliances | 5 | 10% |
| Vendors | 2 | 2.5% |
| Subtotal | | 25% |
| Base Rate | | 12% |
| Discount Rate | | 37% |

The discount rate for industry options is calculated using a traditional total cost of capital approach that includes the cost of risk capital in a manner that is well known. After the appropriate discount rates are determined, the value of each real option and contingent liability is calculated using the specified algorithms in a manner that is well known. The real option can be valued using a number of algorithms including Black Scholes, binomial, neural network or dynamic programming algorithms. The industry option bots use the industry rankings from prior processing block to determine an allocation percentage for industry options. The more dominant the enterprise, as indicated by the industry rank for the element indicators, the greater the allocation of industry real options. Every option bot contains the information shown in Table 35.

TABLE 35
1. Unique ID number (based on date, hour, minute, second of creation)
2. Creation date (date, hour, minute, second)
3. Mapping information
4. Storage location
5. Organization
6. Industry or Enterprise
7. Real option type (Industry or Enterprise)
8. Real option algorithm (Black Scholes, Quadranomial,
Dynamic Program, etc.)

After the option bots are initialized, they activate in accordance with the frequency specified by the user (20) in the system settings table (140). After being activated, the bots retrieve information as required to complete the option valuations. When they are used, industry option bots go on to allocate a percentage of the calculated value of industry options to the enterprise on the basis of causal element strength. After the value of the real option, contingent liability or allocated industry option is calculated the resulting values are tagged then saved in the matrix data table (143) in the application database (50) by enterprise before processing advances to a block 432. Alternative methods of achieving the same results using the information in the matrix data table (143) and the industry ranking table (154) would include using a risk free interest rate for valuing the option and adding event risk for the likelihood of competitor pre-emption based on relative industry strength and

The software in block 432 checks the bot date table (149) and deactivates any cash flow bots with creation dates before the current system date. The software in the block then retrieves the information from the system settings table (140) and the matrix data table (143) as required to initialize cash flow bots for each enterprise in accordance with the frequency specified by the user (20) in the system settings table (140). Bots are independent components of the application that have specific tasks to perform. In the case of cash flow bots, their primary tasks are to calculate the cash flow for each enterprise for every time period where data are available and to forecast a steady state cash flow for each enterprise in the organization. Cash flow is calculated using the forecast revenue, expense, capital change and depreciation data retrieved from the matrix data table (143) with a well-known formula where cash flow equals period revenue minus period expense plus the period change in capital plus non-cash depreciation/amortization for the period. The steady state cash flow for each enterprise is calculated for the enterprise using forecasting methods identical to those disclosed previously in U.S. Pat. No. 5,615,109 to forecast revenue, expenses, capital changes and depreciation separately before calculating the cash flow. Every cash flow bot contains the information shown in Table 36.

TABLE 36
1. Unique ID number (based on date, hour, minute, second of creation)
2. Creation date (date, hour, minute, second)
3. Mapping information
4. Storage location
5. Organization
6. Enterprise

After the cash flow bots are initialized, the bots activate in accordance with the frequency specified by the user (20) in the system settings table (140). After being activated the bots, retrieve the forecast data for each enterprise from the matrix data table (143) and then calculate a steady state cash flow forecast by enterprise. The resulting values by period for each enterprise are then stored in the cash flow table (141) in the application database (50) before processing advances to a block 433.

The software in block 433 checks the system settings table (140) in the application database (50) to determine if the current calculation is a new calculation or a structure change. If the calculation is not a new calculation or a structure change, then processing advances to a software block 445. Alternatively, if the calculation is new or a structure change, then processing advances to a software block 441.

The software in block 441 uses the cash flow by period data from the cash flow table (141) and the calculated requirement for working capital to calculate the value of excess financial assets for every time period by enterprise and stores the results of the calculation in the financial forecasts table (150) in the application database before processing advances to a block 442.

The software in block 442 checks the bot date table (149) and deactivates any financial value bots with creation dates before the current system date. The software in block 442 then retrieves the information from the system settings table (140) and the matrix data table (143) as required to initialize financial value bots for the derivatives and excess financial assets in accordance with the frequency specified by the user (20) in the system settings table (140). Bots are independent components of the application that have specific tasks to perform. In the case of financial value bots, their primary task is to their task is to calculate the contribution of every element of value, sub-element of value, element combination, value driver, external factor and factor combination to the derivative and excess financial asset segments of value by enterprise. The system of the present invention uses 12 different types of predictive models to determine relative contribution: neural network; CART; projection pursuit regression; generalized additive model (GAM); GARCH; MMDR; redundant regression network; boosted Naive Bayes Regression; the support vector method; MARS; linear regression; and stepwise regression. The model having the smallest amount of error as measured by applying the mean squared error algorithm to the test data is the best fit model. The “relative contribution algorithm” used for completing the analysis varies with the model that was selected as the “best-fit” as described previously. Every financial value bot activated in this block contains the information shown in Table 37.

TABLE 37
1. Unique ID number (based on date, hour, minute, second of creation)
2. Creation date (date, hour, minute, second)
3. Mapping information
4. Storage location
5. Organization
6. Enterprise
7. Derivative or Excess Financial Asset
8. Element, sub-element, factor, element combination,
factor combination or value driver
9. Predictive model type

After the software in block 442 initializes the financial value bots, the bots activate in accordance with the frequency specified by the user (20) in the system settings table (140). Once activated, they retrieve the required information and sub-divide the data into two sets, one for training and one for testing. The same set of training data is used by each of the different types of bots for each model. After the financial bots complete their processing, the software in block 432 saves the calculated value contributions in the matrix data table (143) by enterprise. The calculated value contributions by element or external factor for excess financial assets are also saved in the financial forecasts table (150) by enterprise in the application database (50) and processing advances to a block 443.

The software in block 443 checks the bot date table (149) and deactivates any element life bots with creation dates before the current system date. The software in block 443 then retrieves the information from the system settings table (140), the system settings table (140) and the matrix data table (143) as required to initialize element life bots for each element and sub-element of value for each enterprise in the organization being analyzed.

Bots are independent components of the application that have specific tasks to perform. In the case of element life bots, their primary task is to determine the expected life of each element and sub-element of value. There are three methods for evaluating the expected life of the elements and sub-elements of value. Elements of value that are defined by a population of members or items (such as: channel partners, customers, employees and vendors) will have their lives estimated by analyzing and forecasting the lives of the members of the population. The forecasting of member lives will be determined by the “best” fit solution from competing life estimation methods including the Iowa type survivor curves, Weibull distribution survivor curves, Gompertz-Makeham survivor curves, polynomial equations using the methodology for selecting from competing forecasts disclosed in U.S. Pat. No. 5,615,109. Elements of value (such as some parts of Intellectual Property i.e. patents and insurance contracts) that have legally defined lives will have their lives calculated using the time period between the current date and the expiration date of the element or sub-element. Finally, elements of value and sub-element of value (such as brand names, information technology and processes) that may not have defined lives and/or that may not consist of a collection of members will have their lives estimated as a function of the enterprise Competitive Advantage Period (CAP). In the latter case, the estimate will be completed using the element vector trends and the stability of relative element strength. More specifically, lives for these element types are estimated by

1) subtracting time from the CAP for element volatility that exceeds cap volatility; and/or

2) subtracting time for relative element strength that is below the leading position and/or relative element strength that is declining;

The resulting values are tagged and stored in the matrix data table (143) for each element and sub-element of value by enterprise. Every element life bot contains the information shown in Table 38.

TABLE 38
1. Unique ID number (based on date, hour, minute, second of creation)
2. Creation date (date, hour, minute, second)
3. Mapping information
4. Storage location
5. Organization
6. Enterprise
7. Element or sub-element of value
8. Life estimation method (item analysis, date calculation
or relative to CAP)

After the element life bots are initialized, they are activated in accordance with the frequency specified by the user (20) in the system settings table (140). After being activated, the bots retrieve information for each element and sub-element of value from the matrix data table (143) as required to complete the estimate of element life. The resulting values are then tagged and stored in the matrix data table (143) by enterprise in the application database (50) before processing advances to a block 445.

The software in block 445 checks the system settings table (140) in the application database (50) to determine if the current calculation is a new calculation or a structure change. If the calculation is not a new calculation or a structure change, then processing advances to a software block 502. Alternatively, if the calculation is new or a structure change, then processing advances to a software block 448.

The software in block 448 checks the bot date table (149) and deactivates any component capitalization bots with creation dates before the current system date. The software in block 448 then retrieves the information from the system settings table (140) and the matrix data table (143) as required to initialize component capitalization bots for each enterprise in the organization.

Bots are independent components of the application that have specific tasks to perform. In the case of component capitalization bots, their task is to determine the capitalized value of the components and subcomponents of value—forecast revenue, forecast expense or forecast changes in capital for each enterprise in the organization in accordance with the formula shown in Table 39.

TABLE 39

Value = F_{f1}/(1 + K) + F_{f2}/(1 + K)² + F_{f3}/(1 + K)³ +
F_{f4}/(1 + K)⁴ + (F_{f4} × (1 + g))/(1 + K)⁵) + (F_{f4} × (1 + g)²)/
(1 + K)⁶) . . . + (F_{f4} × (1 + g)^{N})/(1 + K)^{N+4})
Where:
F_{fx} = Forecast revenue, expense or capital requirements for year × after valuation date (from advanced finance system)
N = Number of years in CAP (from prior calculation)
K = Total average cost of capital − % per year (from prior calculation)
g = Forecast growth rate during CAP − % per year (from advanced financial system)

After the calculation of capitalized value of every component and sub-component of value is complete, the results are tagged and stored in the matrix data table (143) by enterprise in the application database (50). Every component capitalization bot contains the information shown in Table 40.

TABLE 40
1. Unique ID number (based on date, hour, minute, second of creation)
2. Creation date (date, hour, minute, second)
3. Mapping information
4. Storage location
5. Organization
6. Enterprise
7. Component of value (revenue, expense or capital change)
8. Sub component of value

After the component capitalization bots are initialized, they activate in accordance with the frequency specified by the user (20) in the system settings table (140). After being activated, the bots retrieve information for each component and sub-component of value from the matrix data table (143) as required to calculate the capitalized value of each component for each enterprise in the organization. The resulting values are then tagged and saved in the matrix data table (143) in the application database (50) by enterprise before processing advances to a block 449.

The software in block 449 checks the bot date table (149) and deactivates any current operation bots with creation dates before the current system date. The software in block 449 then retrieves the information from the system settings table (140), the matrix data table (143) and the financial forecasts table (150) as required to initialize bots for each element of value, sub-element of value, combination of elements, value driver and/or external factor for the current operation.

Bots are independent components of the application that have specific tasks to perform. In the case of current operation bots, their task is to calculate the contribution of every element of value, sub-element of value, element combination, value driver, external factor and factor combination to the current operation segment of enterprise value. For calculating the current operation portion of element value, the bots use the procedure outlined in Table 9. The first step in completing the calculation in accordance with the procedure outlined in Table 9, is determining the relative contribution of each element, sub-element, combination of elements or value driver by using a series of predictive models to find the best fit relationship between:

1. The element of value vectors, element combination vectors and external factor vectors, factor combination vectors and value drivers and the enterprise components of value they correspond to; and

2. The sub-element of value vectors and the element of value they correspond to.

The system of the present invention uses 12 different types of predictive models to identify the best fit relationship: neural network; CART; projection pursuit regression; generalized additive model (GAM); GARCH; MMDR; redundant regression network; boosted Naive Bayes Regression; the support vector method; MARS; linear regression; and stepwise regression. The model having the smallest amount of error as measured by applying the mean squared error algorithm to the test data is the best fit model. The “relative contribution algorithm” used for completing the analysis varies with the model that was selected as the “best-fit”. For example, if the “best-fit” model is a neural net model, then the portion of revenue attributable to each input vector is determined by the formula shown in Table 41.

TABLE 41
$( {\sum }_{k = 1}^{k = m} {\sum }_{j = 1}^{j = n} {I}_{jk} X {O}_{k} / {\sum }_{j = 1}^{j = n} {I}_{i k} ) / {\sum }_{k = 1}^{k = m} {\sum }_{j = 1}^{j = n} {I}_{jk} X {O}_{k \\}$

Where
Iⱼₖ = Absolute value of the input weight from input node j to hidden node k
Oₖ = Absolute value of output weight from hidden node k
M = number of hidden nodes
N = number of input nodes

After the relative contribution of each element of value, sub-element of value, external factor, element combination, factor combination and value driver to the components of current operation value is determined, the results of this analysis are combined with the previously calculated information regarding element life and capitalized component value to complete the valuation of each: element of value, sub-element of value, external factor, element combination, factor combination and/or value driver using the approach shown in Table 9.
The resulting values are tagged and stored in the matrix data table (143) for each element of value, sub-element of value, element combination, factor combination and value driver by enterprise. For external factor and factor combination value calculations, the external factor percentage is multiplied by the capitalized component value to determine the external factor value. The resulting values for external factors are also tagged and saved in the matrix data table (143) by enterprise. Every current operation bot contains the information shown in Table 42.

TABLE 42
1. Unique ID number (based on date, hour, minute, second of creation)
2. Creation date (date, hour, minute, second)
3. Mapping information
4. Storage location
5. Organization
6. Enterprise
7. Element, sub-element, factor, element combination,
factor combination or value driver
8. Component of value (revenue, expense or capital change)

After the current operation bots are initialized by the software in block 449 they activate in accordance with the frequency specified by the user (20) in the system settings table (140). After being activated, the bots retrieve information and complete the valuation for the segment being analyzed. As described previously, the resulting values are then tagged and saved in the matrix data table (143) in the application database (50) by enterprise before processing advances to a block 450.

The software in block 450 checks the bot date table (149) and deactivates any residual bots with creation dates before the current system date. The software in block 450 then retrieves the information from the system settings table (140) and the matrix data table (143) as required to initialize residual bots for the each enterprise in the organization.

Bots are independent components of the application that have specific tasks to perform. In the case of residual bots, their task is to retrieve data and calculate the residual going concern value for each enterprise in accordance with the formula shown in Table 43.

TABLE 43
Residual Going Concern Value = Total Current-Operation Value −
Σ Financial Asset Values − Σ Elements of Value − Σ External Factors

Every residual bot contains the information shown in Table 44.

TABLE 44
1. Unique ID number (based on date, hour, minute, second of creation)
2. Creation date (date, hour, minute, second)
3. Mapping information
4. Storage location
5. Organization
6. Enterprise

After the residual bots are initialized they activate in accordance with the frequency specified by the user (20) in the system settings table (140). After being activated, the bots retrieve information as required to complete the residual calculation for each enterprise. After the calculation is complete, the resulting values are then saved in the matrix data table (143) by enterprise in the application database (50) before processing advances to a software block 451.

The software in block 451 determines the contribution of each element of value to the value of the real option segment of value for each enterprise. For enterprise options, the value of each element is determined by comparing the value of the enterprise options to the value that would have been calculated if the element had an average level of strength. Elements that are relatively strong reduce the discount rate and increase the value of the option. In a similar fashion, elements that are below average in strength increase the discount rate and decrease the value of the option. The value impact can be determined by subtracting the calculated value of the option from the value of the option with the average element. The resulting values are saved in the matrix data table (143) by enterprise before processing advances to block 452.

The software in block 452 checks the bot date table (149) and deactivates any segmentation bots with creation dates before the current system date. The software in the block then retrieves the information from the system settings table (140) and the matrix data table (143) as required to initialize segmentation bots for each enterprise in accordance with the frequency specified by the user (20) in the system settings table (140). Bots are independent components of the application that have specific tasks to perform. In the case of segmentation bots, their primary task is to segment the value of each element, factor, element combination, factor combination or value driver in to a base value and a variability or risk component. The system of the present invention uses wavelet algorithms to segment the value in to two components although other segmentation algorithms such as GARCH could be used to the same effect. Every segmentation bot contains the information shown in Table 45.

TABLE 45
1. Unique ID number (based on date, hour, minute, second of creation)
2. Creation date (date, hour, minute, second)
3. Mapping information
4. Storage location
5. Organization
6. Enterprise
7. Element, sub-element, factor, element combination, factor
combination or value driver
8. Segmentation algorithm

After the segmentation bots are initialized, the bots activate in accordance with the frequency specified by the user (20) in the system settings table (140). After being activated the bots, retrieve the data from the matrix data table (143) and then segment each element, factor, element combination, factor combination or value driver in to two components. The resulting values by period for each enterprise are then stored in the matrix data table (143). As part of this processing the factor risk assignments stored by the user (20) after interacting with the software in block 421 are used to distribute some factor risks to the elements of value before processing advances to a software block 453 where the market risk is calculated.

The software in block 453 checks the bot date table (149) and deactivates any market risk bots with creation dates before the current system date. The software in the block then retrieves the information from the system settings table (140) and the matrix data table (143) as required to initialize market risk bots for each enterprise with a market value in accordance with the frequency specified by the user (20) in the system settings table (140). Bots are independent components of the application that have specific tasks to perform. In the case of market risk bots, their tasks are to determine the market risk for the analysis time periods for each equity of each enterprise with a public market value and to determine the market price of a unit of risk. The market price of risk is the excess return the market requires per unit of volatility. This value can be calculated using the traditional capital asset pricing model in a manner that is well known. The implied risk of each equity is determined using the Black Scholes option pricing algorithm. The Black Scholes algorithm determines the price for an equity option as a function of several variables including the volatility of the equity. When the market price and the other variables in the equation are known, then the Black Scholes algorithm can be used to calculate the implied volatility in the equity in a manner that is well known. Under the traditional capital asset pricing model volatility equals market risk. 3 moment and game-theoretic capital asset pricing models can also be used to calculate the market price of risk and total equity risk to the same effect. Every market risk bot contains the information shown in Table 46.

TABLE 46
1. Unique ID number (based on date, hour, minute, second of creation)
2. Creation date (date, hour, minute, second)
3. Mapping information
4. Storage location
5. Organization
6. Enterprise
7. Time Period(s)
8. Overall Market Risk Measure: implied option volatility

After the market risk bots are initialized, the bots activate in accordance with the frequency specified by the user (20) in the system settings table (140). After being activated the bots, retrieve the data for each enterprise with a market price from the matrix data table (143) and then calculate the implied volatility for each time period. They also calculate the market price of risk implied by the current price levels. The resulting values for each time period are then stored in the matrix data table (143) by enterprise before processing advances to a software block 454 where market sentiment risk is calculated.

The software in block 454 checks the bot date table (149) and deactivates any market sentiment risk bots with creation dates before the current system date. The software in the block then retrieves the information from the system settings table (140) and the matrix data table (143) as required to initialize market sentiment risk bots for the organization in accordance frequency specified by the user (20) in the system settings table (140). Bots are independent components of the application that have specific tasks to perform. In the case of market sentiment risk bots they have two primary tasks. The first task is to transform the previously completed calculations regarding event risk, element variability risk and factor variability risk in to forms where they can be added together. The transformation of the risks is completed by first transforming the event risk information to normal variables. The transformed risk is combined the market price of risk information derived previously so that the layers of an event risk can be more readily compared with the element and factor variability data. The second task is to compare the market risk calculated by the bots in block 453 with the summed total of the event, element and factor risk for the specified time periods. As discussed previously, market sentiment risk is defined as the difference between market risk and the total of all other types of risk. If the organization does not have a market value, then the bots only complete the first task so that the overall total risk can be calculated. Every market sentiment risk bot contains the information shown in Table 47.

TABLE 47
1. Unique ID number (based on date, hour, minute, second of creation)
2. Creation date (date, hour, minute, second)
3. Mapping information
4. Storage location
5. Organization
6. Enterprise
7. Time Period(s)

After the market sentiment risk bots are initialized, the bots activate in accordance with the frequency specified by the user (20) in the system settings table (140). After being activated the bots, retrieve the data for the organization from the matrix data table (143) and then calculate the total of the event, element variability and factor variability risks after the transformations have been completed. If there is a market price, then the value of the market sentiment risk is also calculated. The resulting values for each time period for each enterprise and the organization are then stored in the matrix data table (143) in the application database (50) before processing advances to a software block 455 where market value sentiment is calculated.

The software in block 455 checks the bot date table (149) and deactivates any value sentiment bots with creation dates before the current system date. The software in block 455 then retrieves the information from the system settings table (140) and the matrix data table (143) as required to initialize sentiment calculation bots for the organization. Bots are independent components of the application that have specific tasks to perform. In the case of sentiment calculation bots, their task is to retrieve data as required and then calculate the value sentiment for each enterprise in accordance with the formula shown in Table 48.

TABLE 48
Value Sentiment = Market Value for Enterprise − Current Operation
Value − Σ Real Option Values − Value of Excess
Financial Assets − Σ Derivative Values

Organizations that are not public corporations will, of course, not have a market value so no calculation will be completed for these enterprises. The sentiment for the organization will be calculated by subtracting the total for each of the five segments of value for all enterprises in the organization from the total market value for all enterprises in the organization. Every value sentiment bot contains the information shown in Table 49.

TABLE 49
1. Unique ID number (based on date, hour, minute, second of creation)
2. Creation date (date, hour, minute, second)
3. Mapping information
4. Storage location
5. Organization
6. Enterprise
7. Type: Organization or Enterprise

After the value sentiment bots are initialized, they activate in accordance with the frequency specified by the user (20) in the system settings table (140). After being activated, the bots retrieve information from the system settings table (140), the matrix data table (143) and the financial forecasts table (150) as required to complete the sentiment calculation for each enterprise and the organization. After the calculation is complete, the resulting values are tagged then saved in the matrix data table (143) in the application database (50) before processing advances to a block 456. The software in block 456 checks the bot date table (149) and deactivates any sentiment analysis bots with creation dates before the current system date. The software in block 452 then retrieves the information from the system settings table (140), the matrix data table (143) and the vector table (153) as required to initialize sentiment analysis bots for the enterprise.

Bots are independent components of the application that have specific tasks to perform. In the case of sentiment analysis bots, their primary task is to determine the composition of the calculated sentiment for each enterprise in the organization and the organization as a whole. One part of this analysis is completed by comparing the portion of overall market value that is driven by the different elements of value as determined by the bots in software block 429 and the calculated valuation impact of each element of value on the segments of value as shown below in Table 50.

TABLE 50
Total Enterprise Market Value = $100 Billion, 10% driven by
Brand factors
Implied Brand Value = $100 Billion × 10% = $10 Billion
Brand Element Current Operation Value = $6 Billion
Increase/(Decrease) in Enterprise Real Option Values* Due to
Brand = $1.5 Billion
Increase/(Decrease) in Derivative Values due to Brands = $0.0
Increase/(Decrease) in excess Financial Asset Values due to
Brands = $0.25 Billion
Brand Sentiment = $10 − $6 − $1.5 − $0.0 − $0.25 = $2.25 Billion
*includes allocated industry options when used in the calculation

The sentiment analysis bots also determine the impact of external factors on sentiment. Every sentiment analysis bot contains the information shown in Table 51.

TABLE 51
1. Unique ID number (based on date, hour, minute, second of creation)
2. Creation date (date, hour, minute, second)
3. Mapping information
4. Storage location
5. External factor or element of value
6. Organization
7. Enterprise

After the sentiment analysis bots are initialized, they activate in accordance with the frequency specified by the user (20) in the system settings table (140). After being activated, the bots retrieve information from the system settings table (140), the matrix data table (143), and the financial forecasts table (150) as required to analyze sentiment. The resulting breakdown of sentiment is tagged then saved in the matrix data table (143) by enterprise in the application database (50). Sentiment at the organization level is calculated by adding together the sentiment calculations for all the enterprises in the organization. The results of this calculation are also tagged and saved in the matrix data table (143) in the application database (50) before processing advances to a software block before processing advances to a block 502 where the organization optimization is started.

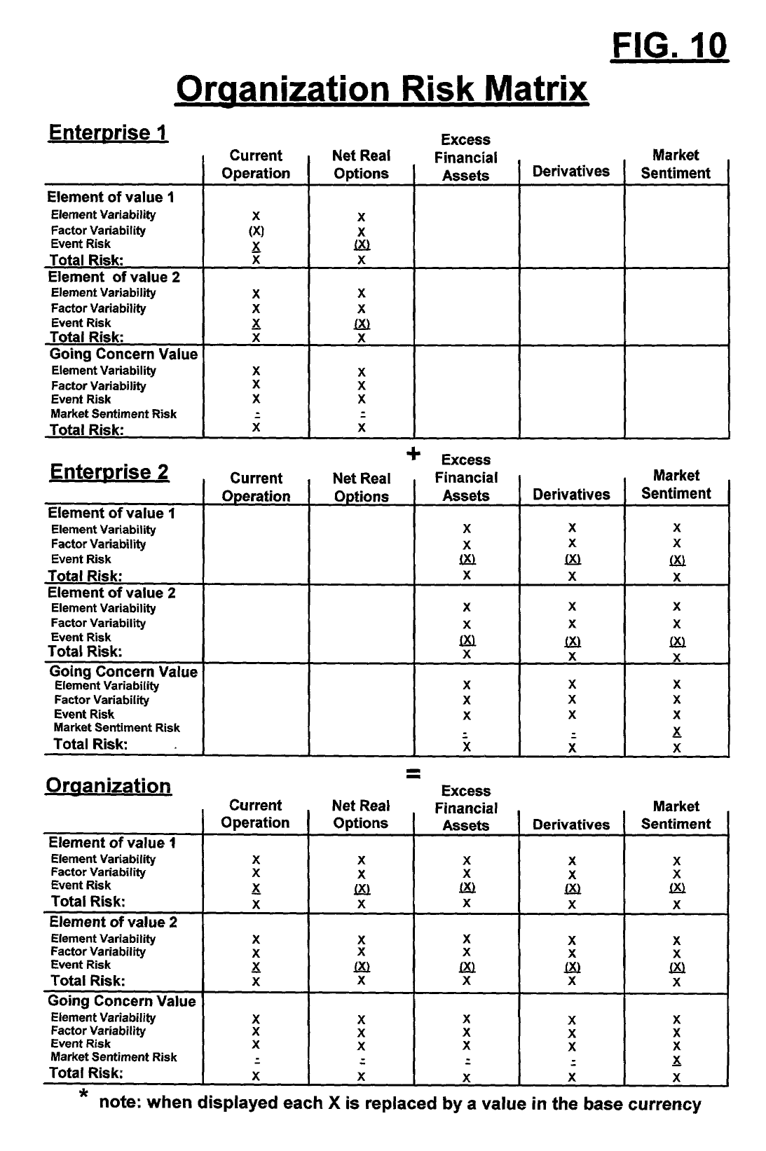

Before going on to discuss organization optimization calculations we should briefly review the processing that has been completed so far. At this point, the organization risk matrix (FIG. 10) and the market value matrix (FIG. 11) have been filled in with values for the organization at the date of system calculation (assumes complete set of data up to and including the date of system calculation has been processed). As detailed above, the matrix of risk includes four types of risk—the risk associated with element variability, the risk associated with factor variability, the risk associated with events and market sentiment risk. To the extent possible, the factor variability risk and the event risk have been placed in the matrix cell that corresponds to the element of value and segment of value that the risk corresponds to. Factor and event risks that have not been distributed to the element of value level are left in the “going concern” element of value. In addition to giving organizations a new level of control over the management of their operational and financial performance, the system of the present invention also greatly enhances the ability to develop securities that bundle risks together for resale and/or mix risk transfer products with equity ownership.

### Optimization

The flow diagram in FIG. 7 details the processing that is completed by the portion of the application software (500) that determines the optimal feature set for the organization and defines the efficient frontier for corporate financial performance under a variety of scenarios.

System processing in this portion of the application software (500) begins in a block 502. The software in block 502 checks the system settings table (140) in the application database (50) to determine if the current calculation is a new calculation or a structure change. If the calculation is not a new calculation or a structure change, then processing advances to a software block 522. Alternatively, if the calculation is new or a structure change, then processing advances to a software block 503.

The software in block 503 checks the bot date table (149) and deactivates any statistical bots with creation dates before the current system date. The software in block 503 then retrieves the information from the system settings table (140) and the matrix data table (143) as required to initialize statistical bots for each causal value driver and external factor.

Bots are independent components of the application that have specific tasks to perform. In the case of statistical bots, their primary tasks are to calculate and store statistics such as mean, median, standard deviation, slope, average period change, maximum period change, variance and covariance for each causal value driver and external factor. Covariance with the market as a whole is also calculated for each value driver and external factor. Every statistical bot contains the information shown in Table 52.

TABLE 52
1. Unique ID number (based on date, hour, minute, second of creation)
2. Creation date (date, hour, minute, second)
3. Mapping information
4. Storage location
5. Organization
6. Enterprise
7. Value driver, element variable or factor variable

### When bots in block 503 have calculated, tagged and stored statistics for each causal value driver and external factor in the matrix data table (143) by enterprise, processing advances to a software block 505.

The software in block 505 checks the bot date table (149) and deactivates any extreme value bots with creation dates before the current system date. The software in block 505 then retrieves the information from the system settings table (140) and the matrix data table (143) as required to initialize extreme value bots in accordance with the frequency specified by the user (20) in the system settings table (140).

Bots are independent components of the application that have specific tasks to perform. In the case of extreme value bots, their primary task is to identify the extreme values for each causal value driver and external factor by enterprise. The extreme value bots use the Blocks method and the peak over threshold method to identify extreme values. Other extreme value algorithms can be used to the same effect. Every extreme value bot activated in this block contains the information shown in Table 53.

TABLE 53
1. Unique ID number (based on date, hour, minute, second of creation)
2. Creation date (date, hour, minute, second)
3. Mapping information
4. Storage location
5. Organization
6. Enterprise
7. Method: blocks or peak over threshold
8. Value driver or external factor

After the extreme value bots are initialized, they activate in accordance with the frequency specified by the user (20) in the system settings table (140). Once activated, they retrieve the required information and determine the extreme value range for each value driver or external factor. The bot tags and saves the extreme values for each causal value driver and external factor in the matrix data table (143) by enterprise in the application database (50) and processing advances to a block 509.

The software in block 509 checks the bot date table (149) and deactivates any forecast bots with creation dates before the current system date. The software in block 505 then retrieves the information from the system settings table (140) and the matrix data table (143) as required to initialize forecast bots in accordance with the frequency specified by the user (20) in the system settings table (140).

Bots are independent components of the application that have specific tasks to perform. In the case of forecast bots, their primary task is to compare the forecasts stored for external factors and financial asset values with the information available from futures exchanges. Every forecast bot activated in this block contains the information shown in Table 54.

TABLE 54
1. Unique ID number (based on date, hour, minute, second of creation)
2. Creation date (date, hour, minute, second)
3. Mapping information
4. Storage location
5. Organization
6. Enterprise
7. External factor or financial asset
8. Forecast time period

After the forecast bots are initialized, they activate in accordance with the frequency specified by the user (20) in the system settings table (140). Once activated, they retrieve the required information and determine if any forecasts need to be changed to bring them in line with the market data on future values. The bot saves the updated forecasts in the appropriate tables in the application database (50) by enterprise and processing advances to a block 510.

The software in block 510 checks the bot date table (149) and deactivates any scenario bots with creation dates before the current system date. The software in block 510 then retrieves the information from the system settings table (140) and the matrix data table (143) as required to initialize scenario bots in accordance with the frequency specified by the user (20) in the system settings table (140).

Bots are independent components of the application that have specific tasks to perform. In the case of scenario bots, their primary task is to identify likely scenarios for the evolution of the causal value drivers and external factors by enterprise. The scenario bots use information from the advanced finance system, external databases and the forecasts completed in the prior stage to obtain forecasts for specific value drivers and factors before using the covariance information stored in the matrix data table (143) to develop forecasts for the other causal value drivers and factors under normal conditions. They also use the extreme value information calculated by the previous bots and stored in the matrix data table (143) to calculate extreme scenarios. Every scenario bot activated in this block contains the information shown in Table 55.

TABLE 55
1. Unique ID number (based on date, hour, minute, second of creation)
2. Creation date (date, hour, minute, second)
3. Mapping information
4. Storage location
5. Type: normal or extreme
6. Organization
7. Enterprise

After the scenario bots are initialized, they activate in accordance with the frequency specified by the user (20) in the system settings table (140). Once activated, they retrieve the required information and develop a variety of scenarios as described previously. After the scenario bots complete their calculations, they save the resulting scenarios in the scenarios table (152) by enterprise in the application database (50) and processing advances to a block 520.

The software in block 520 checks the bot date table (149) and deactivates any simulation bots with creation dates before the current system date. The software in block 510 then retrieves the information from the system settings table (140), the matrix data table (143) and the scenarios table (152) as required to initialize simulation bots in accordance with the frequency specified by the user (20) in the system settings table (140).

Bots are independent components of the application that have specific tasks to perform. In the case of simulation bots, their primary task is to run three different types of simulations for the enterprise. The simulation bots run simulations of organizational financial performance and valuation using: the two types of scenarios generated by the scenario bots—normal and extreme, they also run an unconstrained genetic algorithm simulation that evolves to the most negative value. In addition to examining the economic factors that were identified in the previous stages of analysis, the bots simulate the impact of event risks like fire, earthquakes, floods and other weather-related phenomena that are largely un-correlated with the economic scenarios. The bots also to project the risk associated with competitor actions, government legislation, customer defection and market changes. The information on frequency and cost associated with these events may be found in risk management systems that have been integrated with the present system. However, as discussed previously, external databases (25) may also have contained information that is useful in evaluating the likelihood and potential damage associated with these risks. Every simulation bot activated in this block contains the information shown in Table 56.

TABLE 56
1. Unique ID number (based on date, hour, minute, second of creation)
2. Creation date (date, hour, minute, second)
3. Mapping information
4. Storage location
5. Type: normal, extreme or genetic algorithm
6. Risk factors: economic variability or event
7. Segment of value: current operation, real options, financial assets,
derivatives or market sentiment
8. Organization
9. Enterprise

After the simulation bots are initialized, they activate in accordance with the frequency specified by the user (20) in the system settings table (140). Once activated, they retrieve the required information and simulate the financial performance and value impact of the different scenarios on each segment of value by enterprise. After the simulation bots complete their calculations, the resulting forecasts are saved in the simulation table (157) and the summary data table (156) by enterprise in the application database (50) and processing advances to a block 521.

The software in block 521 checks the bot date table (149) and deactivates any optimization bots with creation dates before the current system date. The software in block 521 then retrieves the information from the system settings table (140), the matrix data table (143), the scenarios table (152) and the simulation table (157) required to initialize value optimization bots in accordance with the frequency specified by the user (20) in the system settings table (140).

Bots are independent components of the application that have specific tasks to perform. In the case of optimization bots, their primary task is to determine the optimal mix of features for the organization under a variety of scenarios for the specified time period (or time periods). The optimal mix of features is the mix that maximizes the value of the market value matrix at the end of the given time period. A genetic algorithm optimization is used to determine the best mix of features for each scenario and time period combination. Other optimization algorithms can be used at this point to achieve the same result. Every optimization bot contains the information shown in Table 57.

TABLE 57
1. Unique ID number (based on date, hour, minute, second of creation)
2. Creation date (date, hour, minute, second)
3. Mapping information
4. Storage location
5. Organization
6. Scenario: normal, extreme or normal-extreme mix
7. Time period

After the software in block 521 initializes the optimization bots, they activate in accordance with the frequency specified by the user (20) in the system settings table (140). After completing their calculations, the resulting feature mix for each set of scenarios and the combined analysis is saved in the summary data table (156) in the application database (50) by enterprise. The shadow prices from these optimizations are also stored in the feature rank table (158) by enterprise for use in identifying new features and feature options that the company may wish to develop and/or purchase. After the results of this optimization are stored in the application database (50) by enterprise, processing advances to a software block 522.

The software in block 522 checks the system settings table (140) in the application database (50) to determine if the current calculation is a new calculation or a structure change. If the calculation is not a new calculation or a structure change, then processing advances to a software block 602. Alternatively, if the calculation is new or a structure change, then processing advances to a software block 523.

The software in block 523 checks the bot date table (149) and deactivates any feature rank bots with creation dates before the current system date. The software in block 523 then retrieves the information from the system settings table (140), the matrix data table (143), the summary data table (156) and the feature rank table (158) as required to initialize feature rank bots for every feature and causal value driver.

Bots are independent components of the application that have specific tasks to perform. In the case of feature rank bots, their primary task is to rank all of the features, feature options and causal value drivers that the organization can change to improve value and/or reduce risk. Causal value drivers are analyzed to give the user (20) insight in to actions that may improve value that haven't been identified as features. The feature rank bots rely on the market value matrix developed in the prior stage of processing to rank all of the different features and feature options that are available to the system for financial measurement and optimization. Every feature, feature option and value driver is ranked on the basis its value impact, risk impact and overall value impact net of investment for each scenario. Features, options and value drivers are also ranked on the basis of capital efficiency which is their overall value impact before deducting capital investment over the capital investment required to implement the feature or feature option. Features, options and value drivers that don't require capital investment will have their value impact divided by 0.01 to determine their capital efficiency ranking. Every feature rank bot contains the information shown in Table 58.

TABLE 58
1. Unique ID number (based on date, hour, minute, second of creation)
2. Creation date (date, hour, minute, second)
3. Mapping information
4. Storage location
5. Organization
6. Scenario: normal, extreme or combined
7. Feature, feature option or causal value driver

After the software in block 523 initializes the feature rank bots, they activate in accordance with the frequency specified by the user (20) in the system settings table (140). After completing their calculations, the bots store the ranking for every feature, feature option and causal value driver in the feature rank table (158) by enterprise before processing advances to a software block 525.

The software in block 525 checks the bot date table (149) and deactivates any frontier bots with creation dates before the current system date. The software in block 525 then retrieves the information from the system settings table (140), the matrix data table (143), the summary data table (156) and the feature rank table (158) as required to initialize frontier bots for each scenario.

Bots are independent components of the application that have specific tasks to perform. In the case of frontier bots, their primary task is to define the efficient frontier for organization financial performance under each scenario. The top leg of the efficient frontier for each scenario is defined by successively adding the features, options and value drivers that increase value while increasing risk to the optimal mix in capital efficiency order. The bottom leg of the efficient frontier for each scenario is defined by successively adding the features, options and value drivers that decrease value while decreasing risk to the optimal mix in capital efficiency order. Every frontier bot contains the information shown in Table 59.

TABLE 59
1. Unique ID number (based on date, hour, minute, second of creation)
2. Creation date (date, hour, minute, second)
3. Mapping information
4. Storage location
5. Organization
6. Scenario: normal, extreme or combined
7. Feature, feature option or causal value driver

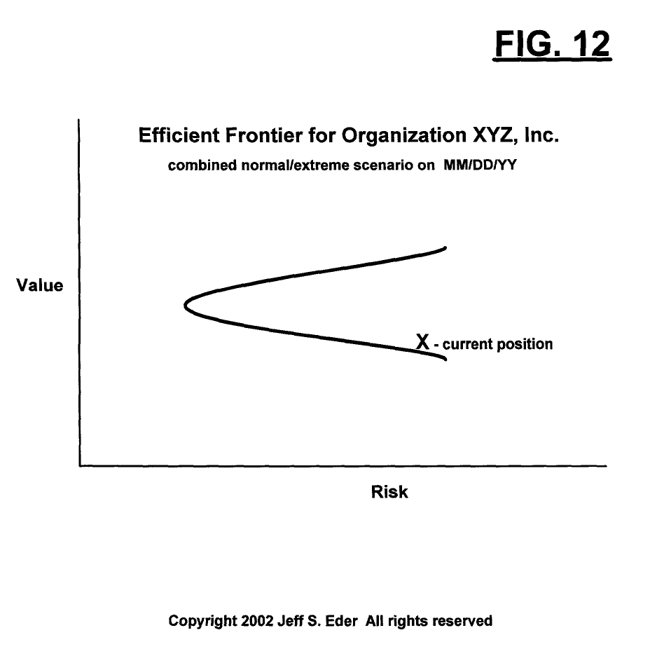

After the software in block 525 initializes the feature rank bots, they activate in accordance with the frequency specified by the user (20) in the system settings table (140). After completing their calculations, the results of all 3 sets of calculations (normal, extreme and combined) are saved in the report table (155) in sufficient detail to generate a chart like the one shown in FIG. 12 before processing advances to a block 526.

The software in block 526 checks the analysis definition table (148) in the application database (50) to determine if the current calculation a structure change analysis. If the calculation is not a structure change analysis, then processing advances to a software block 602. Alternatively, if the calculation is a structure change analysis, then processing advances to a software block 610.

### Analysis & Output

The flow diagram in FIG. 8 details the processing that is completed by the portion of the application software (600) that generates the market value matrix for the organization, generates a summary of the value, risk and liquidity for the organization, analyzes changes in organization structure and operation and optionally displays and prints management reports detailing the value matrix, risk matrix and the efficient frontier. Processing in this portion of the application starts in software block 602.

The software in block 602 retrieves information from the system settings table (140), the cash flow table (141), the matrix data table (143) and the financial forecasts table (150) that is required to calculate the minimum amount of working capital that will be available during the forecast time period. The system settings table (140) contains the minimum amount of working capital that the user (20) indicated was required for enterprise operation while the cash flow table (141) contains a forecast of the cash flow of the enterprise for each period during the forecast time period (generally the next 36 months). A summary of the available cash and cash deficits by currency, by month, for the next 36 months is stored in a summary xml format in the summary data table (156) by enterprise during this stage of processing. After the amount of available cash for each enterprise and the organization is calculated and stored in the feature rank table (158), processing advances to a software block 603.

The software in block 603 retrieves information from the matrix data table (143), financial forecasts table (150) and the summary data table (156) as required to generate the matrix of market value (FIG. 11) by enterprise for the organization for each scenario. The matrices are stored in the report table (155) and a summary version of the data is added to the summary data table (156). The software in this block also creates and displays a summary Market Value Map™ Report for the organization via the analysis definition window (708). The software in the block then prompts the user (20) via the analysis definition window (708) to specify changes in the organization that should be analyzed. The user (20) is given the option of: adding new features and feature options, re-defining the structure for analysis purposes, examining the impact of changes in segments of value, components of value, elements of value and/or external factors on organization market value. For example, the user (20) may wish to:

1. redefine the efficient frontier without considering the impact of market sentiment on organization value—this analysis would be completed by temporarily re-defining the structure and completing a new analysis;

2. redefine the efficient frontier after adding in the matrix of market value for another enterprise that may be purchased—this analysis would be completed by temporarily re-defining the structure and completing a new analysis;

3. forecast the likely impact of a project on organization value and risk—this analysis would be completed by mapping the expected results of the project to the market value matrix and then repeating the processing to determine if the organization would be closer to or further from the original efficient frontier after project implementation;

4. forecast the impact of changing economic conditions on the organizations ability to repay its debt—this analysis would be completed by mapping the expected changes to organization market value matrix, recalculating value, liquidity and risk and then determining if the organization will in a better position to repay its debt; or

5. maximize revenue from all enterprises in the organization—this analysis would be completed by temporarily defining a new structure that included only the revenue component of value and repeating the processing described previously.

### The software in block 603 saves the analysis definitions the user (20) specifies in the analysis definition table (148) in the application database (50) before processing advances to a software block 606.

The software in block 606 checks the analysis definition table (148) in the application database (50) to determine if the user (20) has specified an analysis for computation. If an analysis has been specified, then processing returns to block 303 and the processing described previously is repeated with the changes defined in the analysis definition table being used in completing system calculations. After the analysis run is completed, the software in block 608 displays the results of the analysis via the analysis definition window (708) before processing advances to a software block 610. Alternatively, if the user (20) did not request an analysis, then processing advances directly to a software block 610.

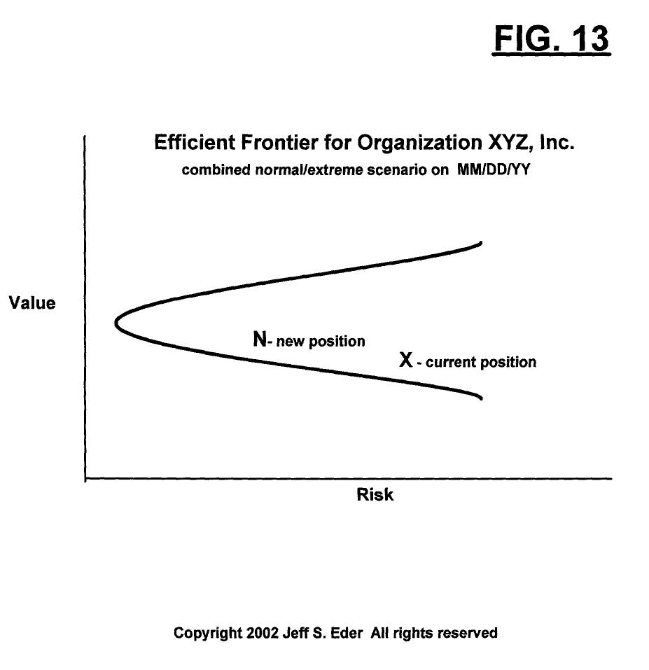

The software in block 610 prompts the user (20) to approve the release of data requests stored in the data request table (144) with the report display and selection window (706). Information regarding data request approvals is stored in the data request table (144) and transmitted back to software block 240. The software in block 610 also prompts the user (20) to optionally selects reports for display and/or printing using one or more frames. The format of the reports is either graphical, numeric or both depending on the type of report the user (20) specified in the system settings table (140). Typical formats for graphical reports displaying the efficient frontier are shown in FIG. 12 and FIG. 13. The user can also choose to have reports displayed and/or printed that compare the actual and forecast risk and return for the organization to the risk and return for the benchmark return previously saved in the benchmark return table (147). The report can also show if the organization's return differs from the return that would be expected given the difference between the organization's risk and the risk of the benchmark portfolio. The expected difference in return can be calculated using the different versions of the capital asset pricing model. If the user (20) selects any reports for printing, then the information regarding the selected reports is saved in the report table (155). After the user (20) has finished selecting reports, the selected reports are displayed to the user (20). After the user (20) indicates that the review of the reports has been completed, processing advances to a software block 611.

The software in block 611 checks the report table (155) to determine if any reports have been designated for printing. If reports have been designated for printing, then processing advances to a block 615. It should be noted that in addition to standard reports like the market value matrix, the matrix of organization risk, the Market Value Map™ report and the graphical depictions of the efficient frontier shown in FIG. 12 and FIG. 13 the system of the present invention can generate reports that rank the elements, external factors and/or the risks in order of their importance to value and risk by enterprise segment of value, by organization segment of value, by enterprise and/or for the organization as a whole. The system can also produce “metrics” reports by tracing the historical measures for value drivers over time. The software in block 615 sends the designated reports to the printer (118). After the reports have been sent to the printer (118), processing advances to a software block 617. Alternatively, if no reports were designated for printing, then processing advances directly from block 611 to block 617.

The software in block 617 checks the system settings table (140) to determine if the system is operating in a continuous run mode. If the system is operating in a continuous run mode, then processing returns to block 303 and the processing described previously is repeated in accordance with the frequency specified by the user (20) in the system settings table (140). Alternatively, if the system is not running in continuous mode, then the processing advances to a block 618 where the system stops.

Thus, the reader will see that the system and method described above transforms disparate narrow systems in to an integrated system for measuring and optimizing the financial performance of a multi-enterprise organization. The level of detail, breadth and speed of the financial analysis gives users of the integrated system the ability to manage their operations in an fashion that is superior to any method currently available to users of the isolated, narrowly focused management systems.

While the above description contains many specificities, these should not be construed as limitations on the scope of the invention, but rather as an exemplification of one preferred embodiment thereof. Accordingly, the scope of the invention should be determined not by the embodiment illustrated, but by the appended claims and their legal equivalents.

1-68. (canceled)

69. A computer program product embodied on a computer readable medium and comprising program code for directing at least one computer to perform the steps in a brand risk management method, comprising:
establishing a standard definition for a plurality of data attributes where said data attributes include at least one brand element of value,
obtaining a plurality of data from a plurality of narrow systems, a plurality of external databases, an Internet and a plurality of user input where said data includes data for one or more keywords, one or more event risks and one or more features,
preparing said data for use in processing in accordance with said standard definitions, analyzing at least a portion of the data with a series of models as required to identify a plurality of performance indicators for the brand element of value and each of a plurality of other elements of value and a plurality of external factors that have an impact on financial performance,
developing one or more: element of value impact summaries, external factor impact summaries, scenarios and models of financial performance by segment of value using said performance indicators and said event risk data, and
simulating financial performance using said models under said scenarios as required to quantify a plurality of risks for the brand element of value, the other elements of value and the external factors
where a plurality of performance indicators further comprise one or more keyword context indicators and indicators selected from the group consisting of keyword indicators, element of value indicators, external factor indicators and combinations thereof,
where a plurality of risks further comprise event risks and risks selected from the group consisting of variability risk, market volatility risk, strategic risk, contingent liability and combinations thereof.

70. A computer program product as in claim 69, wherein a feature comprises an option for managing one or more elements of value, one or more external factors or one or more risks of the organization.

71. A computer program product as in claim 69, wherein a plurality of other elements of value are selected from the group consisting of alliances, bonds, channels, content, customers, customer relationships, derivatives, employees, employee relationships, information technology, intellectual property, knowledge, partnerships, processes, production equipment, products, securities, supply chains, technology, vendors, vendor relationships and combinations thereof.

72. A computer program product as in claim 69, wherein each of one or more external factors are selected from the group consisting of numerical indicators of economic conditions external to the organization, numerical indications of prices external to the organization, numerical indications of organization conditions compared to external expectations of organization condition, numerical indications of the organization performance compared to external expectations of organization performance and combinations thereof.

73. A computer program product as in claim 69, wherein a plurality of narrow systems are selected from the group consisting of advanced financial systems, asset management systems, basic financial systems, alliance management systems, brand management systems, customer relationship management systems, channel management systems, estimating systems, intellectual property management systems, process management systems, supply chain management systems, vendor management systems, operation management systems, enterprise resource planning systems (ERP), material requirement planning systems (MRP), quality control systems, sales management systems, human resource systems, accounts receivable systems, accounts payable systems, capital asset systems, inventory systems, invoicing systems, payroll systems, purchasing systems, web site systems, financial service provider systems, IT asset management systems, business intelligence systems, call management systems, channel management systems, content management systems, demand chain systems, email management systems, employee relationship management systems, energy risk management systems, fraud management systems, incentive management systems, innovation management systems, investor relationship management systems, knowledge management systems, location management systems, maintenance management systems, partner relationship management systems, performance management systems (for IT assets), price optimization systems, private exchanges, product life-cycle management systems, project portfolio management systems, risk simulation systems, sales force automation systems, scorecard systems, service management systems, six-sigma quality management systems, support chain systems, technology chain systems, unstructured data management systems, weather risk management systems, workforce management systems, yield management systems and combinations thereof.

74. A computer program product as in claim 69, wherein one or more models of financial performance further comprise a model of financial performance for each of one or more segments of value where the segments of value are selected from the group consisting of current operation, derivative, investment, market sentiment, real option and combinations thereof.

75. A computer program product as in claim 69, wherein a brand further comprises elements selected from the group consisting of: a symbol indicating ownership, a symbol indicating source, a device indicating ownership, a device indicating source, a mark, a hallmark, a label, a logo, a logotype, a trade mark, a stamp, a tag, a seal, a distinctive style, a model, a cut, a line, a make, a pattern, a specific characteristic, a reputation, a trait and combinations thereof.

76. A computer program product as in claim 69, wherein the method further comprises:
identifying one or more changes in one or more features that will optimize one or more aspects of financial performance selected from the group consisting of risk, value and combinations thereof,
identifying said changes using a paper document or electronic display, and optionally implementing said feature changes by communicating with one or more narrow systems.

77. A computer program product as in claim 69, wherein one or more scenarios are selected from the group consisting of normal, extreme and combinations thereof.

78. A computer program product as in claim 69, wherein preparing a plurality of data for use in processing in accordance with a standard definition further comprises tagging said data with a set of economic logic integration identification information and storing said data in a file or table in an application database.

79. A brand risk management method, comprising:
establishing a standard definition for a plurality of data attributes where said data attributes include at least one brand element of value,
obtaining a plurality of data from a plurality of narrow systems, a plurality of external databases, an Internet and a plurality of user input where said data includes data for one or more keywords, one or more event risks and one or more features,
preparing said data for use in processing in accordance with said standard definitions, analyzing at least a portion of the data with a series of models as required to identify a plurality of performance indicators for the brand element of value and each of a plurality of other elements of value and a plurality of external factors that have an impact on financial performance,
developing one or more: element of value impact summaries, external factor impact summaries, scenarios and models of financial performance by segment of value using said performance indicators and said event risk data, and
simulating financial performance using said models under said scenarios as required to quantify a plurality of risks for the brand element of value, the other elements of value and the external factors
where a plurality of performance indicators further comprise one or more keyword context indicators and indicators selected from the group consisting of keyword indicators, element of value indicators, external factor indicators and combinations thereof,
where a segment of value is selected from the group consisting of current operation, real option, derivative, investment, market sentiment and combinations thereof, and
where a plurality of risks further comprise event risks and risks selected from the group consisting of variability risk, market volatility risk, strategic risk, contingent liability and combinations thereof.

80. The method of claim 79, wherein each of one or more elements of value are selected from the group consisting of alliances, bonds, brands, channels, content, customers, customer relationships, employees, employee relationships, information technology, intellectual property, knowledge, partnerships, processes, production equipment, products, securities, supply chain technology, vendors, vendor relationships and combinations thereof.

81. The method of claim 79, wherein each of one or more external factors is selected from the group consisting of numerical indicators of economic conditions external to the organization, numerical indications of prices external to the organization, numerical indications of organization conditions compared to external expectations of organization condition, numerical indications of the organization performance compared to external expectations of organization performance and combinations thereof.

82. The method of claim 79, wherein a plurality of narrow systems are selected from the group consisting of advanced financial systems, asset management systems, basic financial systems, alliance management systems, brand management systems, customer relationship management systems, channel management systems, estimating systems, intellectual property management systems, process management systems, supply chain management systems, vendor management systems, operation management systems, enterprise resource planning systems (ERP), material requirement planning systems (MRP), quality control systems, sales management systems, human resource systems, accounts receivable systems, accounts payable systems, capital asset systems, inventory systems, invoicing systems, payroll systems, purchasing systems, web site systems, financial service provider systems, IT asset management systems, business intelligence systems, call management systems, channel management systems, content management systems, demand chain systems, email management systems, employee relationship management systems, energy risk management systems, fraud management systems, incentive management systems, innovation management systems, investor relationship management systems, knowledge management systems, location management systems, maintenance management systems, partner relationship management systems, performance management systems (for IT assets), price optimization systems, private exchanges, product life-cycle management systems, project portfolio management systems, risk simulation systems, sales force automation systems, scorecard systems, service management systems, six-sigma quality management systems, support chain systems, technology chain systems, unstructured data management systems, weather risk management systems, workforce management systems, yield management systems and combinations thereof.

83. The method of claim 79, wherein a brand further comprises elements selected from the group consisting of: a symbol indicating ownership, a symbol indicating source, a device indicating ownership, a device indicating source, a mark, a hallmark, a label, a logo, a logotype, a trade mark, a stamp, a tag, a seal, a distinctive style, a model, a cut, a line, a make, a pattern, a specific characteristic, a reputation, a trait and combinations thereof.

84. The method of claim 79, wherein the method further comprises:
identifying one or more feature changes that will optimize market value, risk and combinations thereof,
identifying said changes using a paper document or electronic display, and and
optionally implementing said feature changes by communicating with one or more narrow systems.

85. The method of claim 79, wherein one or more scenarios are selected from the group consisting of normal, extreme and combinations thereof.

86. The method of claim 79, wherein a keyword indicator is selected from the group consisting of keyword count, keyword ratio, keyword trend, time lagged keyword values and combinations thereof.

87. The method of claim 79, wherein a keyword context indicator is developed using a Bayesian analysis.

88. A computer program product embodied on a computer readable medium and comprising program code for directing at least one computer to perform the steps in a management method, comprising:
establishing a standard definition for a plurality of data attributes where said data attributes include at least one brand element of value,
obtaining a plurality of data from a plurality of narrow systems, a plurality of external databases, an Internet and a plurality of user input where said data includes data for one or more keywords, one or more event risks and one or more features,
preparing said data for use in processing in accordance with said standard definitions,
analyzing at least a portion of the data with a series of models as required to identify a plurality of performance indicators for the brand element of value and each of a plurality of other elements of value and a plurality of external factors that have an impact on financial performance,
developing one or more: element of value impact summaries, external factor impact summaries, scenarios and models of financial performance by segment of value using said performance indicators and said event risk data, and
simulating organization financial performance using said models under said scenarios as required to quantify a market value and a plurality of risks by an element of value, external factor and segment of value
where a segment of value is selected from the group consisting of current operation, real option, derivative, investment, market sentiment and combinations thereof, and
where a plurality of risks further comprise event risks and risks selected from the group consisting of variability risk, market volatility risk, strategic risk, contingent liability and combinations thereof.

89. A computer program product as in claim 88, wherein each of one or more elements of value are selected from the group consisting of alliances, bonds, channels, content, customers, customer relationships, employees, employee relationships, information technology, intellectual property, knowledge, partnerships, processes, production equipment, products, securities, supply chain, technology, vendors, vendor relationships and combinations thereof.

90. A computer program product as in claim 88, wherein each of one or more external factors is selected from the group consisting of numerical indicators of economic conditions external to the organization, numerical indications of prices external to the organization, numerical indications of organization conditions compared to external expectations of organization condition, numerical indications of the organization performance compared to external expectations of organization performance and combinations thereof.

91. A computer program product as in claim 88, wherein a plurality of narrow systems are selected from the group consisting of advanced financial systems, asset management systems, basic financial systems, alliance management systems, brand management systems, customer relationship management systems, channel management systems, estimating systems, intellectual property management systems, process management systems, supply chain management systems, vendor management systems, operation management systems, enterprise resource planning systems (ERP), material requirement planning systems (MRP), quality control systems, sales management systems, human resource systems, accounts receivable systems, accounts payable systems, capital asset systems, inventory systems, invoicing systems, payroll systems, purchasing systems, web site systems, financial service provider systems, IT asset management systems, business intelligence systems, call management systems, channel management systems, content management systems, demand chain systems, email management systems, employee relationship management systems, energy risk management systems, fraud management systems, incentive management systems, innovation management systems, investor relationship management systems, knowledge management systems, location management systems, maintenance management systems, partner relationship management systems, performance management systems (for IT assets), price optimization systems, private exchanges, product life-cycle management systems, project portfolio management systems, risk simulation systems, sales force automation systems, scorecard systems, service management systems, six-sigma quality management systems, support chain systems, technology chain systems, unstructured data management systems, weather risk management systems, workforce management systems, yield management systems and combinations thereof.

92. A computer program product as in claim 88, wherein a keyword context indicator is developed using a Bayesian analysis.

93. A computer program product as in claim 88, wherein the method further comprises:
identifying one or more feature changes that will optimize aspects of financial performance selected from the group consisting of total risk, market value and combinations thereof,
identifying said changes using a paper document or electronic display, and and
optionally implementing said feature changes by communicating with one or more narrow systems.

94. A computer program product as in claim 88, wherein one or more scenarios are selected from the group consisting of normal, extreme and combinations thereof.

95. A computer program product as in claim 88, wherein preparing a plurality of data for use in processing in accordance with a standard definition further comprises tagging said data with a set of economic logic integration identification information and storing said data in a file or table in an application database.
